(19) United States
(12) Patent Application Publication
(10) Pub. No.: US 2025/0247732 A1
(43) Pub. Date: Jul. 31, 2025

(54) RESOURCES FOR CROSS-LINK INTERFERENCE (CLI) MEASUREMENT AND REPORTING

(71) Applicant: Lenovo (Singapore) Pte. Limited, Singapore (SG)

(72) Inventor: Khaled Nafez Rauf Ardah, Ilmenau (DE)

(73) Assignee: Lenovo (Singapore) Pte. Limited, Singapore (SG)

(21) Appl. No.: 19/032,303

(22) Filed: Jan. 20, 2025

Related U.S. Application Data
(60) Provisional application No. 63/623,919, filed on Jan. 23, 2024.

(51) Int. Cl. H04W 24/10; H04B 17/318; H04L 5/00; H04L 5/14; H04W 72/1263

(52) U.S. Cl. CPC H04W 24/10; H04B 17/328; H04L 5/0094; H04L 5/14; H04W 72/1263

(57) ABSTRACT

Various aspects of the present disclosure relate to resources for Cross-Link Interference (CLI) measurement and reporting. An apparatus, such as a user equipment (UE), receives from a network equipment (NE) a configuration message for UE-to-UE CLI measurement and reporting, the configuration message including two or more CLI reference signal (RS) (CLI-RS) measurement resources and CLI reporting resources associated with a different number of subbands and different CLI reporting resource types. The UE performs CLI measurement based at least in part on one or more of the CLI-RS measurement resources or the CLI reporting resources to generate a CLI report, and transmits, to the NE, the CLI report using one or more CLI reporting resources of the different CLI reporting resource types.

### RELATED APPLICATION

This application claims priority to U.S. Provisional Application Ser. No. 63/623,919 filed 23 Jan. 2024 entitled “RESOURCES FOR CROSS-LINK INTERFERENCE (CLI) MEASUREMENT AND REPORTING,” the disclosure of which is incorporated by reference herein in its entirety.

### TECHNICAL FIELD

The present disclosure relates to wireless communications, and more specifically to Cross-Link Interference (CLI) measurement and reporting.

### BACKGROUND

A wireless communications system may include one or multiple network communication devices, such as base stations, which may support wireless communications for one or multiple user communication devices, which may be otherwise known as User Equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication to receive, from a Network Equipment (NE), a configuration message for UE-to-UE CLI measurement and reporting, the configuration message including two or more CLI reference signal (RS) (CLI-RS) measurement resources and CLI reporting resources associated with a different number of subbands and different CLI reporting resource types; perform CLI measurement based at least in part on one or more of the CLI-RS measurement resources or the CLI reporting resources to generate a CLI report; and transmit, to the NE, the CLI report using one or more CLI reporting resources of the different CLI reporting resource types.

In some implementations of the method and apparatuses for a UE described herein, one or more of the CLI-RS measurement resources or the CLI reporting resources include at least one of: one or more subband-based CLI-RS measurement resources associated with a plurality of Layer 3 (L3)-based subband CLI reporting resources; one or more subband-based CLI-RS measurement resources associated with a plurality of Layer 1 (L1)/Layer 2 (L2)-based subband CLI reporting resources; at least one of one or more first triggering conditions or one or more first triggering rules for triggering an L3-based-to-L1/L2-based subband CLI measurement resource and CLI reporting resource; at least one of one or more second triggering conditions or one or more second triggering rules for triggering an L3-based-from-L1/L2-based subband CLI-RS measurement resource and CLI reporting resource; or one or more Scheduling Request (SR) resources associated with one or more of SR triggering conditions or SR triggering rules.

In some implementations of the method and apparatuses for a UE described herein, one or more of the first triggering conditions, the first triggering rules, the second triggering conditions, or the second triggering rules include one or more of: one or more of triggering conditions or triggering rules to trigger high-granularity subband-based CLI-RS measurement resources and CLI reporting resources to low-granularity subband-based CLI-RS measurement resources and CLI reporting resources; one or more of triggering conditions or triggering rules to trigger high-granularity subband-based CLI-RS measurement resources and CLI reporting resources from low-granularity subband-based CLI-RS measurement resources and CLI reporting resources; one or more of triggering conditions or triggering rules to trigger uniform-size subband-based CLI-RS measurement resources and CLI reporting resources to nonuniform-based subband-based CLI-RS measurement resources and CLI reporting resources; or one or more of triggering conditions or triggering rules to trigger uniform-size subband-based CLI-RS measurement resources and CLI reporting resources from nonuniform-based subband-based CLI-RS measurement resources and CLI reporting resources; the CLI-RS measurement resources include one or more of Sounding Reference Signal Reference Signal Received Power (SRS-RSRP) or CLI Received Signal Strength Indicator (CLI-RSSI) resources; different subband-based CLI-RS measurement resources and CLI reporting resources include one or more of different granularity of subbands or different subband sizes; one or more of the CLI-RS measurement resources or the CLI reporting resources are indicated for one or more of Subband Full Duplex (SBFD) and non-SBFD symbols or SBFD and non-SBFD slots.

In some implementations of the method and apparatuses for a UE described herein, one or more of the CLI-RS measurement resources or the CLI reporting resources are indicated for one or more of SBFD symbols or SBFD slots, and one or more of the CLI-RS measurement resources or the CLI reporting resources are indicated for one or more of non-SBFD symbols or non-SBFD slots; two or more of the CLI-RS measurement resources are associated with one CLI reporting resource; two or more of the CLI reporting resources are associated with one CLI-RS measurement resource; one or more of the CLI-RS measurement resources and CLI reporting resources are indicated as active, and one or more of the CLI-RS measurement resources and CLI reporting resources are indicated as inactive; the at least one processor is configured to cause the UE to use one or more triggering conditions to activate one or more inactive CLI-RS measurement resources and one or more inactive CLI reporting resources; the at least one processor is configured to cause the UE to use one or more triggering conditions to deactivate one or more active CLI-RS measurement resources and one or more active CLI reporting resources; the at least one processor is configured to cause the UE to transmit a notification message to the NE indicating one or more of indexes of activated CLI-RS measurement resources and activated CLI reporting resources, or indexes of deactivated CLI-RS measurement resources and deactivated CLI reporting resources.

In some implementations of the method and apparatuses for a UE described herein, the at least one processor is configured to cause the UE to transmit the notification message via an Uplink Control Information (UCI) message; the at least one processor is configured to cause the UE to receive an activation message from the NE to activate one or more inactive CLI-RS measurement resources and activate one or more inactive CLI reporting resources; the at least one processor is configured to cause the UE to receive a deactivation message from the NE to deactivate one or more active CLI-RS measurement resources and deactivate one or more active CLI reporting resources; the at least one processor is configured to cause the UE to receive an activation message from the NE to activate one or more triggering conditions; the at least one processor is configured to cause the UE to receive a deactivation message from the NE to deactivate one or more triggering conditions.

In some implementations of the method and apparatuses for a UE described herein, the at least one processor is configured to cause the UE to receive, from the NE and via one or more of a Downlink Control Information (DCI) message, a Radio Resource Control (RRC) message, or a medium access-control control-element (MAC-CE) message, one or more of: an activation message to activate one or more inactive CLI-RS measurement resources and activate one or more inactive CLI reporting resources; a deactivation message to deactivate one or more active CLI-RS measurement resources and deactivate one or more active CLI reporting resources; an activation message to activate one or more triggering conditions; or a deactivation message from the NE to deactivate one or more triggering conditions; the UE is configured with CLI-RS measurement resources for CLI monitoring without associated CLI reporting resources; the at least one processor is configured to cause the UE to transmit, to the NE, a SR message for a CLI reporting resource configuration in response to a trigger of a SR condition; the SR message indicates at least one of a CLI-RS measurement resource type index, a CLI reporting resource type index, a measured CLI level, or an index of the triggered SR condition.

In some implementations of the method and apparatuses for a UE described herein, the at least one processor is configured to cause the UE to receive, from NE, a Scheduling Grant (SG) message indicating one or more CLI-RS measurement resources, CLI reporting resources, or a combination thereof; the at least one processor is configured to cause the UE to receive the SG message via one or more of a DCI message or a RRC message; the at least one processor is configured to cause the UE to transmit, to the NE, a SR message for the CLI measurement and reporting configurations in response to a trigger of a SR condition; the SR message indicates at least one of a CLI-RS measurement resource type index, a CLI reporting resource type index, a measured CLI level, or an index of the triggered SR condition; the at least one processor is configured to cause the UE to receive, from NE, a SG message indicating one or more CLI-RS measurements resources, CLI reporting resources, or a combination thereof; the at least one processor is configured to cause the UE to receive the SG message via one or more of a DCI message or a RRC message.

Some implementations of the method and apparatuses described herein may further include a processor for wireless communication to receive, at a UE and from a NE, a configuration message for UE-to-UE CLI measurement and reporting, the configuration message including two or more CLI-RS measurement resources and CLI reporting resources associated with a different number of subbands and different CLI reporting resource types; perform CLI measurement based at least in part on one or more of the CLI-RS measurement resources or the CLI reporting resources to generate a CLI report; and transmit, to the NE, the CLI report using one or more CLI reporting resources of the different CLI reporting resource types.

In some implementations of the method and apparatuses for a processor described herein, one or more of the CLI-RS measurement resources or the CLI reporting resources include at least one of: one or more subband-based CLI-RS measurement resources associated with a plurality of L3-based subband CLI reporting resources; one or more subband-based CLI-RS measurement resources associated with a plurality of L1/L2-based subband CLI reporting resources; at least one of one or more first triggering conditions or one or more first triggering rules for triggering an L3-based-to-L1/L2-based subband CLI measurement resource and CLI reporting resource; at least one of one or more second triggering conditions or one or more second triggering rules for triggering an L3-based-from-L1/L2-based subband CLI-RS measurement resource and CLI reporting resource; or one or more SR resources associated with one or more of SR triggering conditions or SR triggering rules; one or more of the first triggering conditions, the first triggering rules, the second triggering conditions, or the second triggering rules include one or more of: one or more of triggering conditions or triggering rules to trigger high-granularity subband-based CLI-RS measurement resources and CLI reporting resources to low-granularity subband-based CLI-RS measurement resources and CLI reporting resources; one or more of triggering conditions or triggering rules to trigger high-granularity subband-based CLI-RS measurement resources and CLI reporting resources from low-granularity subband-based CLI-RS measurement resources and CLI reporting resources; one or more of triggering conditions or triggering rules to trigger uniform-size subband-based CLI-RS measurement resources and CLI reporting resources to nonuniform-based subband-based CLI-RS measurement resources and CLI reporting resources; or one or more of triggering conditions or triggering rules to trigger uniform-size subband-based CLI-RS measurement resources and CLI reporting resources from nonuniform-based subband-based CLI-RS measurement resources and CLI reporting resources.

In some implementations of the method and apparatuses for a processor described herein, the CLI-RS measurement resources include one or more of SRS-RSRP or CLI-RSSI resources; different subband-based CLI-RS measurement resources and CLI reporting resources include one or more of different granularity of subbands or different subband sizes; one or more of the CLI-RS measurement resources or the CLI reporting resources are indicated for one or more of SBFD and non-SBFD symbols or SBFD and non-SBFD slots; one or more of the CLI-RS measurement resources or the CLI reporting resources are indicated for one or more of SBFD symbols or SBFD slots, and one or more of the CLI-RS measurement resources or the CLI reporting resources are indicated for one or more of non-SBFD symbols or non-SBFD slots; two or more of the CLI-RS measurement resources are associated with one CLI reporting resource; two or more of the CLI reporting resources are associated with one CLI-RS measurement resource; one or more of the CLI-RS measurement resources and CLI reporting resources are indicated as active, and one or more of the CLI-RS measurement resources and CLI reporting resources are indicated as inactive.

In some implementations of the method and apparatuses for a processor described herein, the at least one controller is configured to cause the processor to use one or more triggering conditions to activate one or more inactive CLI-RS measurement resources and one or more inactive CLI reporting resources; the at least one controller is configured to cause the processor to use one or more triggering conditions to deactivate one or more active CLI-RS measurement resources and one or more active CLI reporting resources; the at least one controller is configured to cause the processor to transmit a notification message to the NE indicating one or more of indexes of activated CLI-RS measurement resources and activated CLI reporting resources, or indexes of deactivated CLI-RS measurement resources and deactivated CLI reporting resources; the at least one controller is configured to cause the processor to transmit the notification message via an UCI message; the at least one controller is configured to cause the processor to receive an activation message from the NE to activate one or more inactive CLI-RS measurement resources and activate one or more inactive CLI reporting resources.

In some implementations of the method and apparatuses for a processor described herein, the at least one controller is configured to cause the processor to receive a deactivation message from the NE to deactivate one or more active CLI-RS measurement resources and deactivate one or more active CLI reporting resources; the at least one controller is configured to cause the processor to receive an activation message from the NE to activate one or more triggering conditions; the at least one controller is configured to cause the processor to receive a deactivation message from the NE to deactivate one or more triggering conditions; the at least one controller is configured to cause the processor to receive, from the NE and via one or more of a DCI message, a RRC message, or a MAC-CE message, one or more of: an activation message to activate one or more inactive CLI-RS measurement resources and activate one or more inactive CLI reporting resources; a deactivation message to deactivate one or more active CLI-RS measurement resources and deactivate one or more active CLI reporting resources; an activation message to activate one or more triggering conditions; or a deactivation message from the NE to deactivate one or more triggering conditions.

In some implementations of the method and apparatuses for a processor described herein, the processor is configured with CLI-RS measurement resources for CLI monitoring without associated CLI reporting resources; the at least one controller is configured to cause the processor to transmit, to the NE, a SR message for a CLI reporting resource configuration in response to a trigger of a SR condition; the SR message indicates at least one of a CLI-RS measurement resource type index, a CLI reporting resource type index, a measured CLI level, or an index of the triggered SR condition; the at least one controller is configured to cause the processor to receive, from NE, a SG message indicating one or more CLI-RS measurement resources, CLI reporting resources, or a combination thereof; the at least one controller is configured to cause the processor to receive the SG message via one or more of a DCI message or a RRC message; the at least one controller is configured to cause the processor to transmit, to the NE, a SR message for the CLI measurement and reporting configurations in response to a trigger of a SR condition; the SR message indicates at least one of a CLI-RS measurement resource type index, a CLI reporting resource type index, a measured CLI level, or an index of the triggered SR condition; the at least one controller is configured to cause the processor to receive, from NE, a SG message indicating one or more CLI-RS measurements resources, CLI reporting resources, or a combination thereof; the at least one controller is configured to cause the processor to receive the SG message via one or more of a DCI message or a RRC message.

Some implementations of the method and apparatuses described herein may further include a method performed by a UE, the method including receiving, from a NE, a configuration message for UE-to-UE CLI measurement and reporting, the configuration message including two or more CLI-RS measurement resources and CLI reporting resources associated with a different number of subbands and different CLI reporting resource types; performing CLI measurement based at least in part on one or more of the CLI-RS measurement resources or the CLI reporting resources to generate a CLI report; and transmitting, to the NE, the CLI report using one or more CLI reporting resources of the different CLI reporting resource types.

In some implementations of the method and apparatuses described herein, the method further includes where one or more of the CLI-RS measurement resources or the CLI reporting resources include at least one of: one or more subband-based CLI-RS measurement resources associated with a plurality of L3-based subband CLI reporting resources; one or more subband-based CLI-RS measurement resources associated with a plurality of L1/L2-based subband CLI reporting resources; at least one of one or more first triggering conditions or one or more first triggering rules for triggering an L3-based-to-L1/L2-based subband CLI measurement resource and CLI reporting resource; at least one of one or more second triggering conditions or one or more second triggering rules for triggering an L3-based-from-L1/L2-based subband CLI-RS measurement resource and CLI reporting resource; or one or more SR resources associated with one or more of SR triggering conditions or SR triggering rules; one or more of the first triggering conditions, the first triggering rules, the second triggering conditions, or the second triggering rules include one or more of: one or more of triggering conditions or triggering rules to trigger high-granularity subband-based CLI-RS measurement resources and CLI reporting resources to low-granularity subband-based CLI-RS measurement resources and CLI reporting resources; one or more of triggering conditions or triggering rules to trigger high-granularity subband-based CLI-RS measurement resources and CLI reporting resources from low-granularity subband-based CLI-RS measurement resources and CLI reporting resources; one or more of triggering conditions or triggering rules to trigger uniform-size subband-based CLI-RS measurement resources and CLI reporting resources to nonuniform-based subband-based CLI-RS measurement resources and CLI reporting resources; or one or more of triggering conditions or triggering rules to trigger uniform-size subband-based CLI-RS measurement resources and CLI reporting resources from nonuniform-based subband-based CLI-RS measurement resources and CLI reporting resources.

In some implementations of the method and apparatuses described herein, the method further includes where the CLI-RS measurement resources include one or more of SRS-RSRP or CLI-RSSI resources; different subband-based CLI-RS measurement resources and CLI reporting resources include one or more of different granularity of subbands or different subband sizes; one or more of the CLI-RS measurement resources or the CLI reporting resources are indicated for one or more of SBFD and non-SBFD symbols or SBFD and non-SBFD slots; one or more of the CLI-RS measurement resources or the CLI reporting resources are indicated for one or more of SBFD symbols or SBFD slots, and one or more of the CLI-RS measurement resources or the CLI reporting resources are indicated for one or more of non-SBFD symbols or non-SBFD slots; two or more of the CLI-RS measurement resources are associated with one CLI reporting resource; two or more of the CLI reporting resources are associated with one CLI-RS measurement resource; one or more of the CLI-RS measurement resources and CLI reporting resources are indicated as active, and one or more of the CLI-RS measurement resources and CLI reporting resources are indicated as inactive; using one or more triggering conditions to activate one or more inactive CLI-RS measurement resources and one or more inactive CLI reporting resources.

In some implementations of the method and apparatuses described herein, the method further includes using one or more triggering conditions to deactivate one or more active CLI-RS measurement resources and one or more active CLI reporting resources; transmitting a notification message to the NE indicating one or more of indexes of activated CLI-RS measurement resources and activated CLI reporting resources, or indexes of deactivated CLI-RS measurement resources and deactivated CLI reporting resources; In some aspects, the techniques described herein relate to a method, further including transmitting the notification message via an UCI message; receiving an activation message from the NE to activate one or more inactive CLI-RS measurement resources and activate one or more inactive CLI reporting resources; receiving a deactivation message from the NE to deactivate one or more active CLI-RS measurement resources and deactivate one or more active CLI reporting resources; receiving an activation message from the NE to activate one or more triggering conditions; receiving a deactivation message from the NE to deactivate one or more triggering conditions.

In some implementations of the method and apparatuses described herein, the method further includes receiving, from the NE and via one or more of a DCI message, a RRC message, or a MAC-CE message, one or more of: an activation message to activate one or more inactive CLI-RS measurement resources and activate one or more inactive CLI reporting resources; a deactivation message to deactivate one or more active CLI-RS measurement resources and deactivate one or more active CLI reporting resources; an activation message to activate one or more triggering conditions; or a deactivation message from the NE to deactivate one or more triggering conditions; the UE is configured with CLI-RS measurement resources for CLI monitoring without associated CLI reporting resources; transmitting, to the NE, a SR message for a CLI reporting resource configuration in response to a trigger of a SR condition; the SR message indicates at least one of a CLI-RS measurement resource type index, a CLI reporting resource type index, a measured CLI level, or an index of the triggered SR condition; receiving, from NE, a SG message indicating one or more CLI-RS measurement resources, CLI reporting resources, or a combination thereof.

In some implementations of the method and apparatuses described herein, the method further includes receiving the SG message via one or more of a DCI message or a RRC message; transmitting, to the NE, a SR message for the CLI measurement and reporting configurations in response to a trigger of a SR condition; the SR message indicates at least one of a CLI-RS measurement resource type index, a CLI reporting resource type index, a measured CLI level, or an index of the triggered SR condition; receiving, from NE, a SG message indicating one or more CLI-RS measurements resources, CLI reporting resources, or a combination thereof; receiving the SG message via one or more of a DCI message or a RRC message.

Some implementations of the method and apparatuses described herein may further include a NE for wireless communication to transmit, to a UE, a configuration message for UE-to-UE CLI measurement and reporting, the configuration message including two or more CLI-RS measurement resources and CLI reporting resources associated with a different number of subbands and different CLI reporting resource types; and receive, from the UE, a CLI report via one or more CLI reporting resources of the different CLI reporting resource types.

In some implementations of the method and apparatuses for a NE described herein, one or more of the CLI-RS measurement resources or the CLI reporting resources include at least one of: one or more subband-based CLI-RS measurement resources associated with a plurality of L3-based subband CLI reporting resources; one or more subband-based CLI-RS measurement resources associated with a plurality of L1/L2-based subband CLI reporting resources; at least one of one or more first triggering conditions or one or more first triggering rules for triggering an L3-based-to-L1/L2-based subband CLI measurement resource and CLI reporting resource; at least one of one or more second triggering conditions or one or more second triggering rules for triggering an L3-based-from-L1/L2-based subband CLI-RS measurement resource and CLI reporting resource; or one or more SR resources associated with one or more of SR triggering conditions or SR triggering rules; one or more of the first triggering conditions, the first triggering rules, the second triggering conditions, or the second triggering rules include one or more of: one or more of triggering conditions or triggering rules to trigger high-granularity subband-based CLI-RS measurement resources and CLI reporting resources to low-granularity subband-based CLI-RS measurement resources and CLI reporting resources; one or more of triggering conditions or triggering rules to trigger high-granularity subband-based CLI-RS measurement resources and CLI reporting resources from low-granularity subband-based CLI-RS measurement resources and CLI reporting resources; one or more of triggering conditions or triggering rules to trigger uniform-size subband-based CLI-RS measurement resources and CLI reporting resources to nonuniform-based subband-based CLI-RS measurement resources and CLI reporting resources; or one or more of triggering conditions or triggering rules to trigger uniform-size subband-based CLI-RS measurement resources and CLI reporting resources from nonuniform-based subband-based CLI-RS measurement resources and CLI reporting resources.

In some implementations of the method and apparatuses for a NE described herein, the CLI-RS measurement resources include one or more of SRS-RSRP or CLI-RSSI resources; different subband-based CLI-RS measurement resources and CLI reporting resources include one or more of different granularity of subbands or different subband sizes; one or more of the CLI-RS measurement resources or the CLI reporting resources are indicated for one or more of SBFD and non-SBFD symbols or SBFD and non-SBFD slots; one or more of the CLI-RS measurement resources or the CLI reporting resources are indicated for one or more of SBFD symbols or SBFD slots, and one or more of the CLI-RS measurement resources or the CLI reporting resources are indicated for one or more of non-SBFD symbols or non-SBFD slots; two or more of the CLI-RS measurement resources are associated with one CLI reporting resource; two or more of the CLI reporting resources are associated with one CLI-RS measurement resource; one or more of the CLI-RS measurement resources and CLI reporting resources are indicated as active, and one or more of the CLI-RS measurement resources and CLI reporting resources are indicated as inactive.

In some implementations of the method and apparatuses for a NE described herein, the at least one processor is configured to cause the NE to receive, from the UE, a notification message indicating one or more of indexes of activated CLI-RS measurement resources and activated CLI reporting resources, or indexes of deactivated CLI-RS measurement resources and deactivated CLI reporting resources; the at least one processor is configured to cause the NE to receive the notification message via an UCI message; the at least one processor is configured to cause the NE to transmit, to the UE, an activation message to activate one or more inactive CLI-RS measurement resources and activate one or more inactive CLI reporting resources; the at least one processor is configured to cause the NE to transmit, to the UE, a deactivation message to deactivate one or more active CLI-RS measurement resources and deactivate one or more active CLI reporting resources; the at least one processor is configured to cause the NE to transmit, to the UE, an activation message to activate one or more triggering conditions.

In some implementations of the method and apparatuses for a NE described herein, the at least one processor is configured to cause the NE to transmit, to the UE, a deactivation message to deactivate one or more triggering conditions; the at least one processor is configured to cause the NE to transmit, to the UE and via one or more of a DCI message, a RRC message, or a MAC-CE message, one or more of: an activation message to activate one or more inactive CLI-RS measurement resources and activate one or more inactive CLI reporting resources; a deactivation message to deactivate one or more active CLI-RS measurement resources and deactivate one or more active CLI reporting resources; an activation message to activate one or more triggering conditions; or a deactivation message from the NE to deactivate one or more triggering conditions; the at least one processor is configured to cause the NE to receive, to from the UE, a SR message for a CLI reporting resource configuration in response to a trigger of a SR condition; the SR message indicates at least one of a CLI-RS measurement resource type index, a CLI reporting resource type index, a measured CLI level, or an index of the triggered SR condition; the at least one processor is configured to cause the NE to transmit, to the UE, a SG message indicating one or more CLI-RS measurement resources, CLI reporting resources, or a combination thereof.

In some implementations of the method and apparatuses for a NE described herein, the at least one processor is configured to cause the NE to transmit the SG message via one or more of a DCI message or a RRC message; the at least one processor is configured to cause the NE to receive, from the UE, a SR message for the CLI measurement and reporting configurations; the SR message indicates at least one of a CLI-RS measurement resource type index, a CLI reporting resource type index, a measured CLI level, or an index of a triggered SR condition; the at least one processor is configured to cause the NE to transmit, to the UE, a SG message indicating one or more CLI-RS measurements resources, CLI reporting resources, or a combination thereof; the at least one processor is configured to cause the NE to transmit the SG message via one or more of a DCI message or a RRC message.

Some implementations of the method and apparatuses described herein may further include a method performed by a NE, the method including transmitting, to a UE, a configuration message for UE-to-UE CLI measurement and reporting, the configuration message including two or more CLI-RS measurement resources and CLI reporting resources associated with a different number of subbands and different CLI reporting resource types; and receiving, from the UE, a CLI report via one or more CLI reporting resources of the different CLI reporting resource types.

In some implementations of the method and apparatuses for a NE described herein, one or more of the CLI-RS measurement resources or the CLI reporting resources include at least one of: one or more subband-based CLI-RS measurement resources associated with a plurality of L3-based subband CLI reporting resources; one or more subband-based CLI-RS measurement resources associated with a plurality of L1/L2-based subband CLI reporting resources; at least one of one or more first triggering conditions or one or more first triggering rules for triggering an L3-based-to-L1/L2-based subband CLI measurement resource and CLI reporting resource; at least one of one or more second triggering conditions or one or more second triggering rules for triggering an L3-based-from-L1/L2-based subband CLI-RS measurement resource and CLI reporting resource; or one or more SR resources associated with one or more of SR triggering conditions or SR triggering rules; one or more of the first triggering conditions, the first triggering rules, the second triggering conditions, or the second triggering rules include one or more of: one or more of triggering conditions or triggering rules to trigger high-granularity subband-based CLI-RS measurement resources and CLI reporting resources to low-granularity subband-based CLI-RS measurement resources and CLI reporting resources; one or more of triggering conditions or triggering rules to trigger high-granularity subband-based CLI-RS measurement resources and CLI reporting resources from low-granularity subband-based CLI-RS measurement resources and CLI reporting resources; one or more of triggering conditions or triggering rules to trigger uniform-size subband-based CLI-RS measurement resources and CLI reporting resources to nonuniform-based subband-based CLI-RS measurement resources and CLI reporting resources; or one or more of triggering conditions or triggering rules to trigger uniform-size subband-based CLI-RS measurement resources and CLI reporting resources from nonuniform-based subband-based CLI-RS measurement resources and CLI reporting resources.

In some implementations of the method and apparatuses for a NE described herein, the CLI-RS measurement resources include one or more of SRS-RSRP or CLI-RSSI resources; different subband-based CLI-RS measurement resources and CLI reporting resources include one or more of different granularity of subbands or different subband sizes; one or more of the CLI-RS measurement resources or the CLI reporting resources are indicated for one or more of SBFD and non-SBFD symbols or SBFD and non-SBFD slots; one or more of the CLI-RS measurement resources or the CLI reporting resources are indicated for one or more of SBFD symbols or SBFD slots, and one or more of the CLI-RS measurement resources or the CLI reporting resources are indicated for one or more of non-SBFD symbols or non-SBFD slots.

In some implementations of the method and apparatuses for a NE described herein, two or more of the CLI-RS measurement resources are associated with one CLI reporting resource; two or more of the CLI reporting resources are associated with one CLI-RS measurement resource; one or more of the CLI-RS measurement resources and CLI reporting resources are indicated as active, and one or more of the CLI-RS measurement resources and CLI reporting resources are indicated as inactive; receiving, from the UE, a notification message indicating one or more of indexes of activated CLI-RS measurement resources and activated CLI reporting resources, or indexes of deactivated CLI-RS measurement resources and deactivated CLI reporting resources; receiving the notification message via an UCI message; transmitting, to the UE, an activation message to activate one or more inactive CLI-RS measurement resources and activate one or more inactive CLI reporting resources; transmitting, to the UE, a deactivation message to deactivate one or more active CLI-RS measurement resources and deactivate one or more active CLI reporting resources.

In some implementations of the method and apparatuses for a NE described herein, further including transmitting, to the UE, an activation message to activate one or more triggering conditions; transmitting, to the UE, a deactivation message to deactivate one or more triggering conditions; transmitting, to the UE and via one or more of a DCI message, a RRC message, or a MAC-CE message, one or more of: an activation message to activate one or more inactive CLI-RS measurement resources and activate one or more inactive CLI reporting resources; a deactivation message to deactivate one or more active CLI-RS measurement resources and deactivate one or more active CLI reporting resources; an activation message to activate one or more triggering conditions; or a deactivation message from the NE to deactivate one or more triggering conditions; receiving, to from the UE, a SR message for a CLI reporting resource configuration in response to a trigger of a SR condition; the SR message indicates at least one of a CLI-RS measurement resource type index, a CLI reporting resource type index, a measured CLI level, or an index of the triggered SR condition; transmitting, to the UE, a SG message indicating one or more CLI-RS measurement resources, CLI reporting resources, or a combination thereof; transmitting the SG message via one or more of a DCI message or a RRC message; receiving, from the UE, a SR message for the CLI measurement and reporting configurations; the SR message indicates at least one of a CLI-RS measurement resource type index, a CLI reporting resource type index, a measured CLI level, or an index of a triggered SR condition; transmitting, to the UE, a SG message indicating one or more CLI-RS measurements resources, CLI reporting resources, or a combination thereof; transmitting the SG message via one or more of a DCI message or a RRC message.

### BRIEF DESCRIPTION OF THE DRAWINGS

FIG. 1 illustrates an example of a wireless communications system in accordance with aspects of the present disclosure.

FIG. 2 illustrates a scenario for wireless communications.

FIG. 3 illustrates a scenario for wireless communications.

FIG. 4, FIG. 5, and FIG. 6 illustrate an information element (IE).

FIG. 7 and FIG. 8 illustrate an IE.

FIG. 9 illustrates a message in accordance with aspects of the present disclosure.

FIG. 10 illustrates a signaling diagram in accordance with aspects of the present disclosure.

FIG. 11 illustrates an example of a UE in accordance with aspects of the present disclosure.

FIG. 12 illustrates an example of a processor in accordance with aspects of the present disclosure.

FIG. 13 illustrates an example of a NE in accordance with aspects of the present disclosure.

FIG. 14 illustrates a flowchart of a method in accordance with aspects of the present disclosure.

FIG. 15 illustrates a flowchart of a method in accordance with aspects of the present disclosure.

### DETAILED DESCRIPTION

Wireless communications systems can utilize duplexing modes for transmitting and receiving data, such as at a UE. For instance, Time Division Duplex (TDD) and Frequency Division Duplex (FDD) are two duplexing modes used by some current wireless networks. TDD uses a same carrier frequency and splits the time resources between the downlink (DL) and Uplink (UL) communications. FDD enables simultaneous UL and DL communications and using different carrier frequencies. Further, Full Duplex (FD) mode enables simultaneous UL and DL communications over the same carrier frequency and same time resource. FD mode can enable gains and enhancements in terms of increasing the system capacity and coverage and/or reducing latency, such as compared to the half-duplex TDD and FDD modes. However, when using the same time and frequency resources for UL and DL communication such as in FD mode, Self-Interference (SI) and CLI issues can arise which can reduce signal quality and increase signal latency.

Accordingly, aspects of the disclosure are directed to supporting flexible CLI measurement and reporting schemes to balance parameters of high-resolution and quicker CLI measurements and reporting and CLI measurements power consumption and reporting overhead. For instance, flexible UE-to-UE CLI measurements and reporting schemes are enabled by configuring a UE with a different CLI-RS measurements and reporting resources configurations, where each configuration may include different number of subbands and different reporting resources type, e.g., L3-based or L1/L2-based reporting.

Further, a serving network node and/or a UE can switch between different provided resources based at least in part on defined rules, e.g., based on configured triggering conditions, rules, and/or based on an activation-deactivation message from the serving network node. The UE may transmit a notification message to the serving network node indicating which resources are active and which resources are inactive. Further, a UE can be configured with one or more of CLI measurement resources and/or monitoring resources and one or more SR triggering conditions, which the UE can use to trigger and transmit a scheduling request message for one or more of CLI-RS measurement resources and/or reporting resources.

Accordingly, the described implementations enable increases in signal quality and decreases in signal latency in wireless communications. Aspects of the present disclosure are described in the context of a wireless communications system.

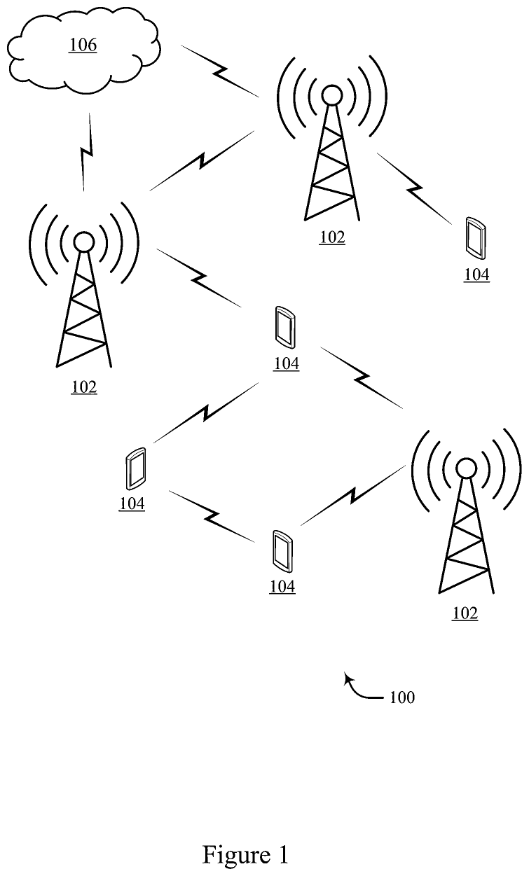

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., Orthogonal Frequency Division Multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 KHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHZ-52.6 GHZ), FR3 (7.125 GHZ-24.25 GHZ), FR4 (52.6 GHz-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., p=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., p=3), which includes 120 kHz subcarrier spacing.

According to implementations, a UE 104 receives, from a NE 102, a configuration message for UE-to-UE CLI measurement and reporting, and the configuration message includes two or more CLI-RS measurement resources and CLI reporting resources associated with a different number of subbands and different CLI reporting resource types. The UE 104 performs CLI measurement based at least in part on one or more of the CLI-RS measurement resources or the CLI reporting resources to generate a CLI report, and transmits, to the NE 102, the CLI report using one or more CLI reporting resources of the different CLI reporting resource types.

TDD and FDD are two duplexing modes used by current wireless networks. TDD uses the same carrier frequency but splits time resources between the DL and UL communications. FDD enables simultaneous UL and DL communications using different carrier frequencies. Full Duplex (FD) mode enables simultaneous UL and DL communications over a same carrier frequency and same time resource. FD mode can enable gains and enhancements in terms of increasing system capacity and coverage and reducing latency compared to half-duplex TDD and FDD modes. However, using the same time and frequency resources for UL and DL communications (e.g., as in FD mode), SI and CLI issues can occur.

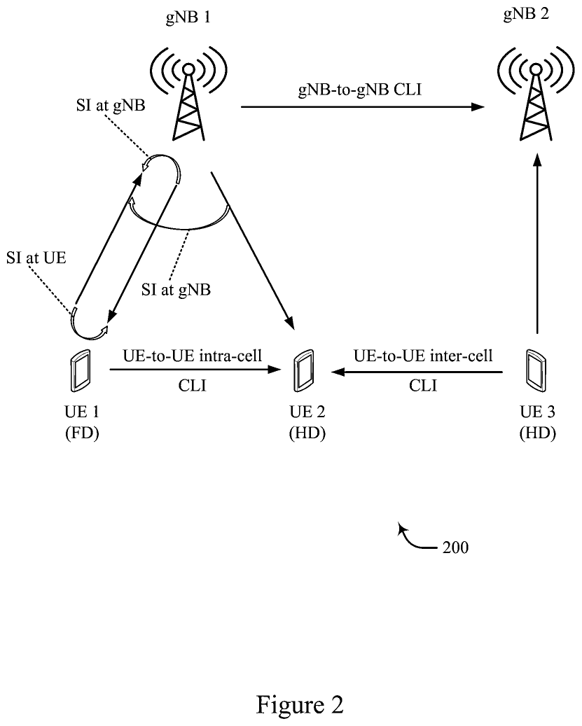

FIG. 2 illustrates a scenario 200 for wireless communications. The scenario 200, for instance illustrates that CLI and SI can occur in a FD mode. SI can occur where the transmitted DL and/or UL signal by a network node (e.g., gNB or UE) leaks energy onto its received UL and/or DL signal. For instance, in the scenario 200, for the SI at gNB 1, the transmitted DL signal and/or channel by gNB I leaks energy onto its received UL signal and/or channel, while for the SI at the UE 1, the transmitted UL signal and/or channel by UE I leaks energy onto its received DL signal and/or channel. For CLI, the transmitted DL and/or UL signal by a network node (e.g., gNB or UE) can leak energy onto received UL and/or DL signal of a nearby node. For instance, in the scenario 200, gNB-to-gNB CLI (e.g., at gNB 2) the transmitted DL signal/channel interfering gNB 1 leaks energy onto the received UL signal and/or channel gNB 2. Further, for UE-to-UE CLI (e.g., at UE 2), the transmitted UL signals and/or channels by UE 1 and UE 3 leaks energy onto received DL signal and/or channel at UE 2.

To optimize benefits of the FD mode, SI and CLI issues are to be properly managed. One solution is to split the frequency resources of a time resource (e.g., symbol or slot) into non-overlapping DL and UL subbands (SBs), where each subband includes one or more of resource-blocks (RBs). Such an approach can reduce the impact of SI and CLI by a degree and has been introduced as study item within 3GPP Rel-18 and called non-overlapping subband full duplex (SBFD).

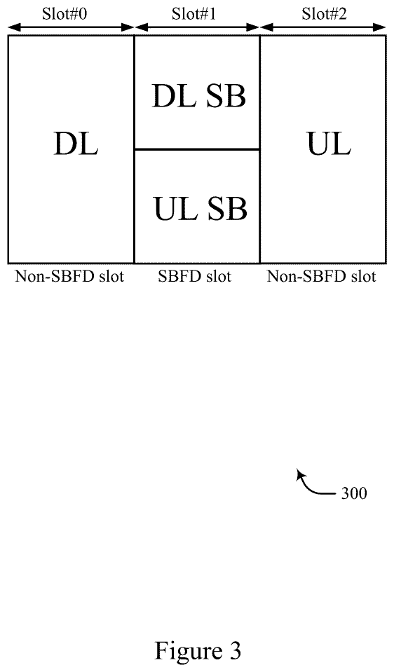

FIG. 3 illustrates a scenario 300 for wireless communications. The scenario 300, for instance, illustrates time slot resources splitting between SBFD-based and non-SBFD-based slots. As illustrated in the scenario 300, the time-domain resources (symbols/slots) with UL and DL SBs are illustrated as SBFD symbols/slots, and the DL-only and the UL-only symbols/slots (e.g., without UL or DL SBs, respectively) are illustrated as non-SBFD symbols/slots. In at least some implementations, the DL and UL SBs within the SBFD symbols/slots are completely non-overlapped, while in some other implementations, the DL and UL SBs within the SBFD symbols/slots are partially or completely overlapped. Other solutions to handle SI and CLI include the use of different antenna panels for DL and UL communications, coordinate scheduling spatial domain, advance receivers, beam nulling, UL and DL power control, etc.

In Rel-16 specifications, to mitigate UE-to-UE CLI, gNBs can exchange and coordinate their intended TDD DL-UL configurations over Xn and FI interfaces, and UEs can be configured to perform and report CLI measurements. Two types of CLI measurements are specified: SRS-RSRP measurements, where a victim UE measures SRS-RSRP over SRS resources transmitted by interfering UEs; and CLI-RSSI measurements, where a UE measures the total received power observed over the indicated RSSI resources. The Rel-16 UE-to-UE CLI framework, however, is based on wideband measurements (e.g., single CLI reporting per CLI resource) and L3-filtered periodical or event triggered reports, and thus may have limited measurement resolution and large latency.

In some scenarios, the current Rel-16 L3-based CLI framework may be sufficient to mitigate and/or avoid inter-UE CLI. In other scenarios, however, a serving gNB may benefit from faster and more granular CLI measurements and reporting to dynamically adjust the scheduled UEs transmission and the reception strategies for UE-to-UE CLI mitigation and/or avoidance. L1/L2 and/or subband-based UE-to-UE CLI measurements and reporting is considered as a solution to improve CLI measurements resolution and to reduce the reporting latency compared to the Rel-16 L3-based reporting framework. However, L1/L2 and/or subband based UE-to-UE CLI measurements and reporting may increase the CLI measurements power consumption and reporting overhead, such as if the number of CLI measurements is large.

As defined in 3GPP Technical Specification (TS) 38.215 V18.0.0 (2023-09), SRS reference signal received power (SRS-RSRP) is defined as linear average of the power contributions (in 12) of the resource elements carrying sounding reference signals (SRS). SRS-RSRP can be measured over the configured resource elements within the considered measurement frequency bandwidth in the configured measurement time occasions. For frequency range 1, the reference point for the SRS-RSRP can be the antenna connector of the UE. For frequency range 2, SRS-RSRP can be measured based on the combined signal from antenna elements corresponding to a given receiver branch. For frequency range 1 and 2, if receiver diversity is in use by the UE, the reported SRS-RSRP value is not to be lower than the corresponding SRS-RSRP of any of the individual receiver branches. This can be applicable for RRC_CONNECTED intra-frequency.

CLI-RSSI can be defined as linear average of the total received power (in 12) observed in the configured OFDM symbols of the configured measurement time resource(s), in the configured measurement bandwidth from multiple sources, including co-channel serving and non-serving cells, adjacent channel interference, thermal noise, etc. For frequency range 1, the reference point for the RSSI can be the antenna connector of the UE. For frequency range 2, CLI-RSSI can be measured based on the combined signal from antenna elements corresponding to a given receiver branch. For frequency range 1 and 2, if receiver diversity is in use by the UE, the reported CLI-RSSI value is not to be lower than the corresponding CLI-RSSI of any of the individual receiver branches. This can be applicable for RRC_CONNECTED intra-frequency.

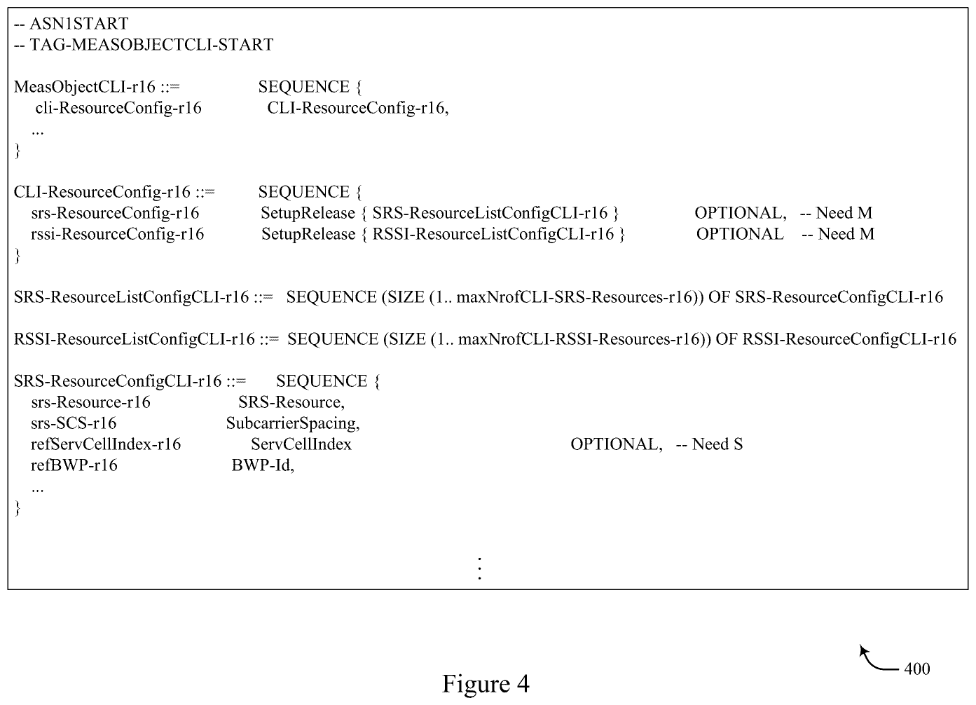

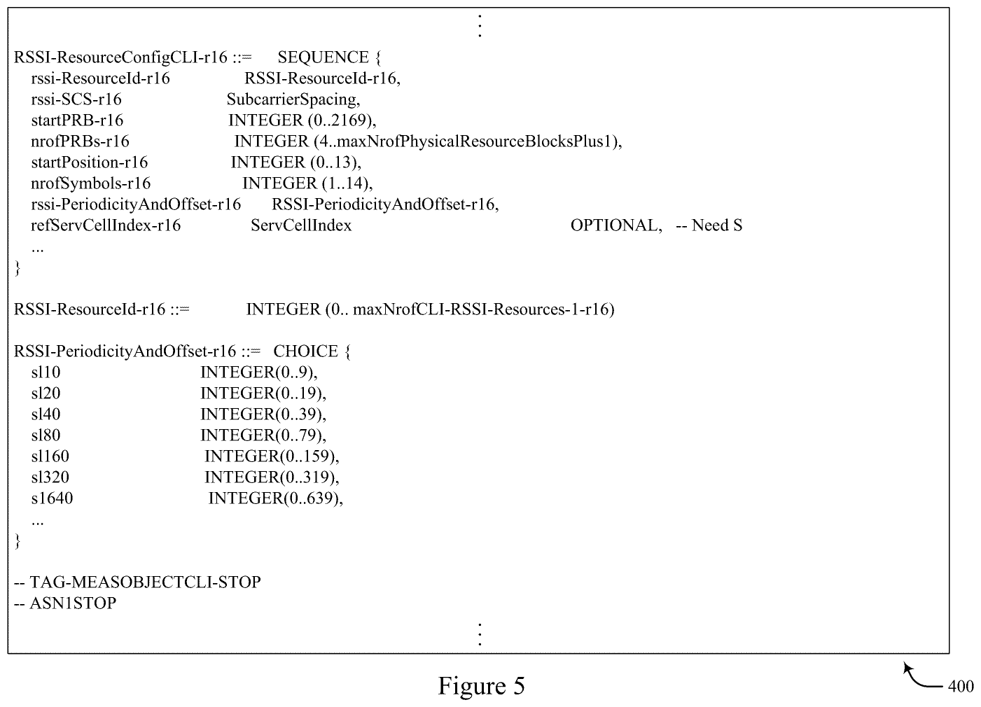

FIG. 4, FIG. 5, and FIG. 6 illustrate an IE 400. The IE 400, for instance, represents a MeasObjectCLI IE that specifies information applicable for SRS-RSRP measurements and/or CLI-RSSI measurements.

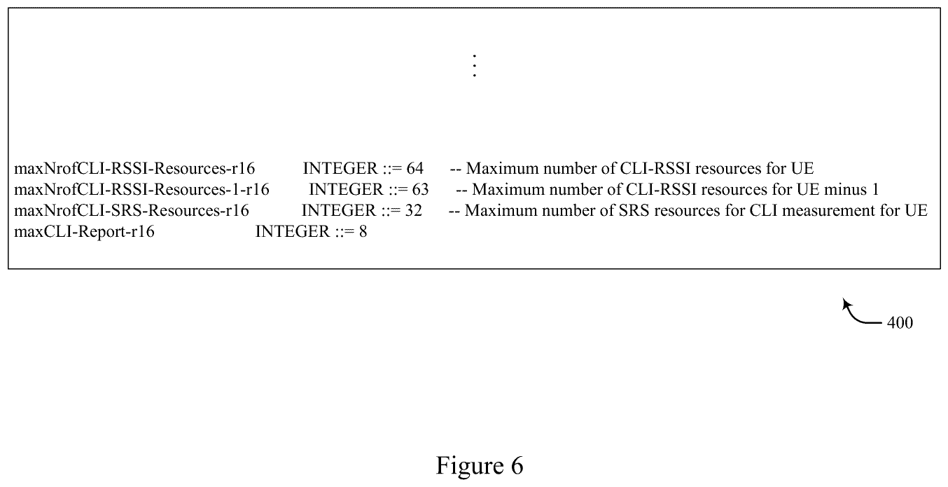

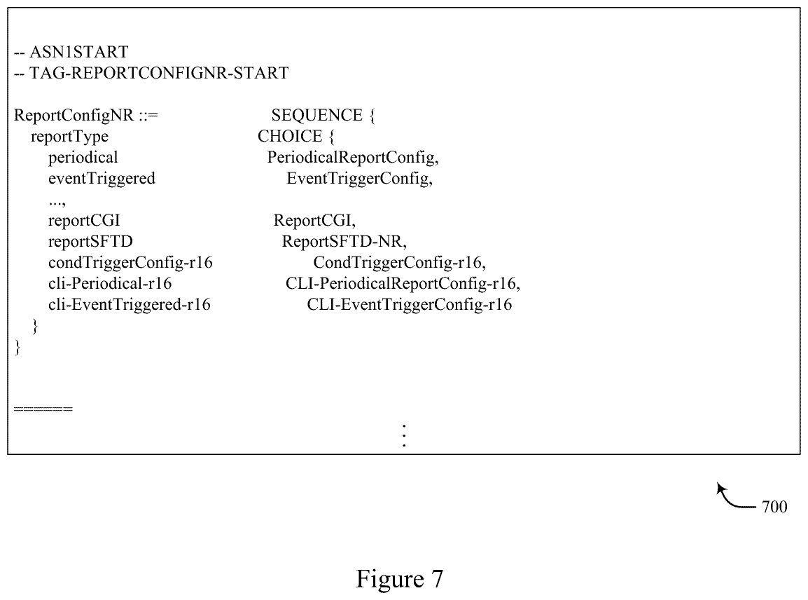

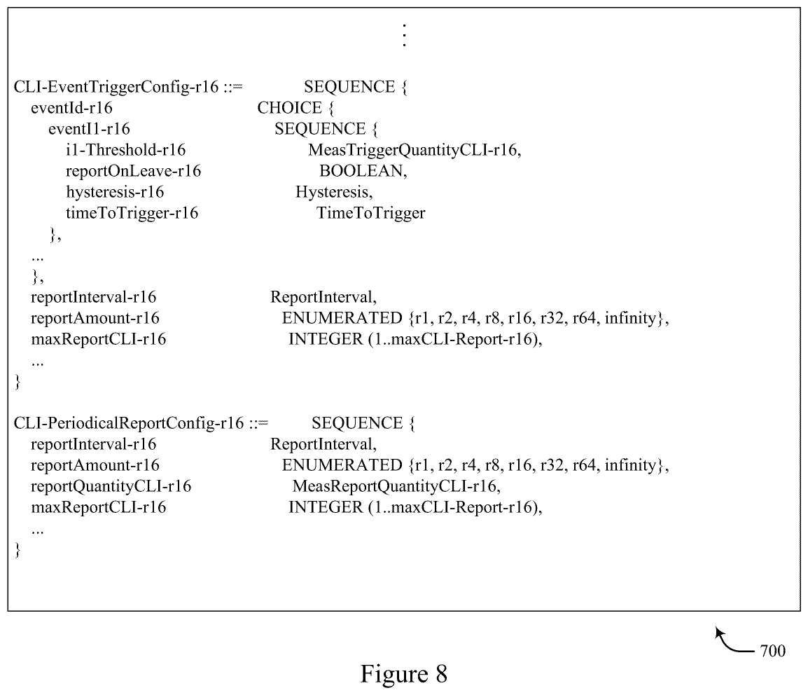

FIG. 7 and FIG. 8 illustrate an IE 700. The IE 700, for instance, represents a ReportConfigNR IE. Example field descriptions for the IEs 400, 700 are presented in Table 1 below.

TABLE 1
IE Field Descriptions

CLI-ResourceConfig field descriptions
srs-ResourceConfig
SRS resources to be used for CLI measurements.
rssi-ResourceConfig
CLI-RSSI resources to be used for CLI measurements.
MeasObjectCLI field descriptions
cli-ResourceConfig
SRS and/or CLI-RSSI resource configuration for CLI measurement.
SRS-ResourceConfigCLI field descriptions
refBWP
DL Bandwidth Part (BWP) id that is used to derive the reference point of the SRS resource (see
TS 38.211[16], clause 6.4.1.4.3)
refServCellIndex
The index of the reference serving cell that the refBWP belongs to. If this field is absent, the
reference serving cell is PCell.
srs-SCS
Subcarrier spacing for SRS. The values 15, 30 kHz or 60 kHz (FR1), and 60 or 120 kHz (FR2) are
applicable.
RSSI-ResourceConfigCLI field descriptions
nrofPRBs
Allowed size of the measurement bandwidth (BW). Multiples of 4 are allowed. The smallest
configurable number is the minimum of 4 and the width of the active DL BWP. If the configured
value is larger than the width of the active DL BWP, the UE can assume that the actual CLI-RSSI
resource bandwidth is within the active DL BWP.
nrofSymbols
Within a slot that is configured for CLI-RSSI measurement (see slotConfiguration), the UE
measures the RSSI from startPosition to startPosition + nrofSymbols −1. The configured CLI-
RSSI resource does not exceed the slot boundary of the reference SCS. If the SCS of configured
DL BWP(s) is larger than the reference SCS, network configures startPosition and nrofSymbols
such that the configured CLI-RSSI resource not to exceed the slot boundary corresponding to the
configured BWP SCS. If the reference SCS is larger than SCS of configured DL BWP(s), network
ensures startPosition and nrofSymbols are integer multiple of reference SCS divided by configured
BWP SCS.
refServCellIndex
The index of the reference serving cell. Frequency reference point of the RSSI resource is
subcarrier 0 of CRB0 of the reference serving cell. If this field is absent, the reference serving cell
is PCell.
rssi-PeriodicityAndOffset
Periodicity and slot offset for this CLI-RSSI resource. Values are in “number of slots”. Value sl1
corresponds to a periodicity of 1 slot, value sl2 corresponds to a periodicity of 2 slots, and so on.
For each periodicity the corresponding offset is given in number of slots.
rssi-SCS
Reference subcarrier spacing for CLI-RSSI measurement. The values 15, 30 kHz or 60 kHz (FR1),
and 60 or 120 kHz (FR2) are applicable. UE performs CLI-RSSI measurement with the SCS of the
active bandwidth part within the configured CLI-RSSI resource in the active BWP regardless of
the reference SCS of the measurement resource.
startPosition
OFDM symbol location of the CLI-RSSI resource within a slot.
startPRB
Starting Physical Resource Block (PRB) index of the measurement bandwidth. For the case where
the reference subcarrier spacing is smaller than subcarrier spacing of active DL BWP(s), network
configures startPRB and nrofPRBs are as a multiple of active BW Subcarrier Spacing (SCS)
divided by reference SCS.
CLI-EventTriggerConfig field descriptions
i1-Threshold
Threshold value associated to the selected trigger quantity (e.g. SRS-RSRP, CLI-RSSI) to be used
in CLI measurement report triggering condition for event i1.
eventId
Choice of CLI event triggered reporting criteria.
maxReportCLI
Max number of CLI measurement resource to include in the measurement report.
reportAmount
Number of measurement reports.
reportOnLeave
Indicates whether or not the UE can initiate the measurement reporting procedure when the
leaving condition is met for a CLI measurement resource in srsTriggeredList or rssiTriggeredList,
as specified in 5.5.4.1.
timeToTrigger
Time during which specific criteria for the event is to be met in order to trigger a measurement
report.
CLI-PeriodicalReportConfig field descriptions
maxReportCLI
Max number of CLI measurement resource to include in the measurement report.
reportAmount
Number of measurement reports.
reportQuantityCLI
The CLI measurement quantities to be included in the measurement report.

Accordingly, the present disclosure presents flexible CLI measurement and reporting schemes to balance parameters of high-resolution and quicker CLI measurements and reporting and CLI measurements power consumption and reporting overhead.

In implementations a UE is configured with a different CLI-RS measurement and reporting resources configurations, where each configuration may include a different number of subbands and different reporting resources type, e.g., L3-based or L1/L2-based reporting. In implementations, one or more of the configured resources are indicated as active, while other resources are indicated as inactive, where a serving network node (e.g., a gNB) and a UE can switch between measurement and reporting resources such as based on criteria and rules, e.g., based on configured triggering conditions, rules, based on an activation-deactivation message from the serving node, etc. In implementations, a UE can be configured with one or more CLI measurement resources, monitoring resources, and/or scheduling request triggering conditions, which the UE can use to trigger and transmit a scheduling request message for one or more of CLI-RS measurements resources and/or reporting resources. Thus, different implementations and signaling aspects are provided herein.

In implementations, a UE receives from a serving network node (e.g., a gNB) a CLI-RS measurement and reporting resources configuration message, where the configuration message indicates one or more of: a plurality of subband-based CLI-RS measurement resources (e.g., SRS-RSRP and/or CLI-RSSI) associated with a plurality of L3-based subband reporting resources; a plurality of subband-based CLI-RS measurement resources (e.g., SRS-RSRP and/or CLI-RSSI) associated with a plurality of L1/L2-based subband reporting resources; a plurality triggering conditions/rules to trigger an L3-based to/from L1/L2-based subband CLI-RS measurements and reporting resources; and/or a plurality of SR resources associated with one or more of SR-triggering conditions/rules.

In at least some examples, the configuration message indicates: different subband-based CLI-RS measurement and reporting resources including different granularity of subbands and/or different subbands sizes (e.g., different subbands are composed of different number of RBs), where the configurations message may include one or more triggering conditions. The triggering conditions, for instance, are configured to trigger high-granularity subband-based CLI-RS measurement and reporting resources to and/or from a low-granularity subband-based CLI measurement and reporting resources, to trigger uniform-size subband-based CLI-RS measurement and reporting resources to and/or from a nonuniform-based subband-based CLI measurement and reporting resources, etc.

In implementations one or more of the CLI-RS measurement and/or reporting resources are specified for both SBFD and non-SBFD symbols and/or slots, e.g., where the CLI-RS measurement resources are confined within DL-only and at least one DL SB of SBFD-based symbols and/or slots, and/or if the CLI reporting resources are confined within UL-only and UL SB of SBFD symbols/slots.

In implementations one or more of the CLI-RS measurements and/or reporting resources are specified for SBFD symbols and/or slots and one or more of the CLI-RS measurements and/or reporting resources are specified for non-SBFD symbols/slots. Two or more of CLI-RS measurement resources can be associated with one CLI reporting resources, and/or two or more of CLI reporting resources can be associated with one CLI-RS measurements resources.

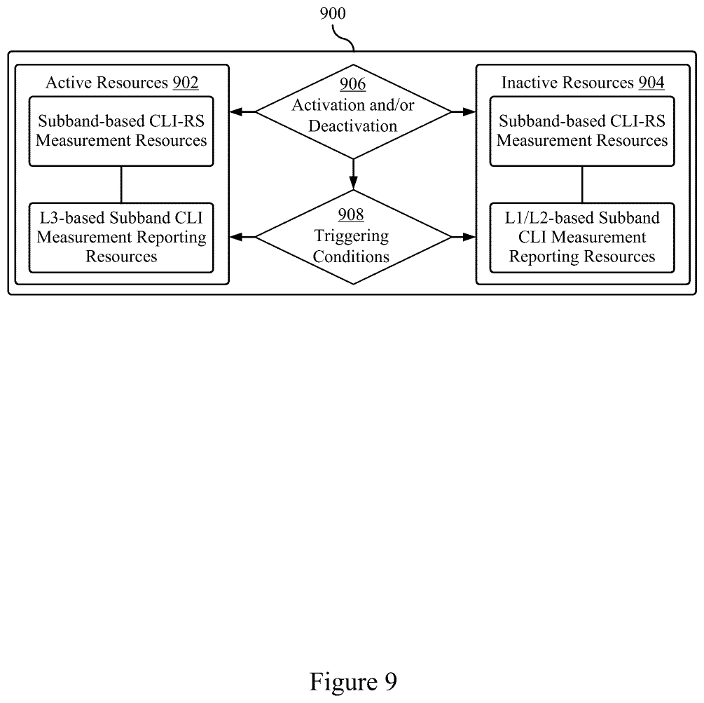

FIG. 9 illustrates a message 900 in accordance with aspects of the present disclosure. The message 900, for instance, represents a CLI-RS measurement and reporting configuration message. The message 900 includes active resources 902, inactive resources 904, activation/deactivation actions 906, and triggering conditions 908.

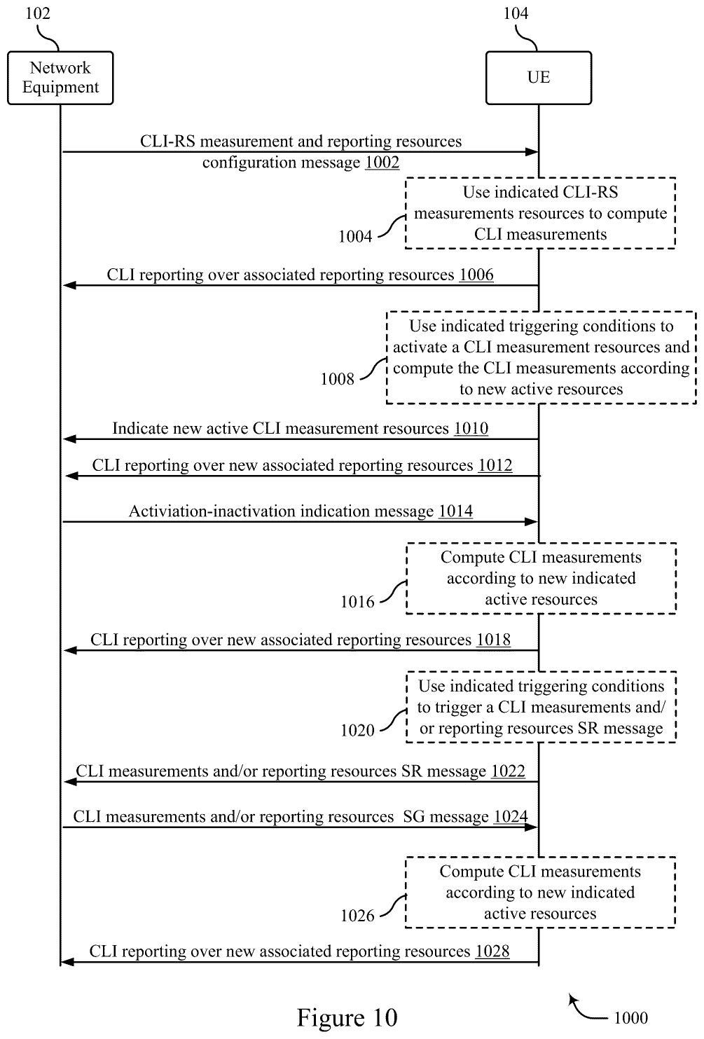

FIG. 10 illustrates a signaling diagram 1000 in accordance with aspects of the present disclosure. The signaling diagram 1000 illustrates signaling between a NE 102 and a UE 104 and includes: CLI-RS measurement and reporting resources configuration message 1002; at 1004 uses indicated CLI-RS measurements resources to compute CLI measurements; CLI reporting over associated reporting resources 1006; at 1008 uses indicated triggering conditions to activate a CLI measurements resources and compute the CLI measurements according to new active resources; at 1010 indicates new active CLI measurement resources; at 1012 performs CLI reporting over new associated reporting resources; at 1014 transmits an activation-inactivation indication message; at 1016 computes CLI measurements according to new indicated active resources; at 1018 performs CLI reporting over new associated reporting resources; at 1020 uses indicated triggering conditions to trigger a CLI measurements and/or reporting resources SR message; at 1022 transmits CLI measurements and/or reporting resources SR message; at 1024 transmits CLI measurements and/or reporting resources SG message; at 1026 computes CLI measurements according to new indicated active resources; and at 1028 transmits CLI reporting over new associated reporting resources.

In implementations such as illustrated in the message 900, a UE is indicated with one or more of active subband-based CLI-RS measurements and L3-based and/or L1/L2-based reporting resources, and other configured and/or indicated resources are indicated as inactive. Further, as illustrated in the message 900, the UE is indicated with a plurality of active subband-based CLI-RS measurement resources associated with L3-based reporting resources and a plurality of inactive subband-based CLI-RS measurement resources associated with L1/L2-based reporting resources. In such scenarios, the UE can use one or more of the following options to switch between resources, e.g., activate one or more of configured resources and/or deactivate one or more of configured resources), such as described below.

In implementations a UE can switch between resources using one or more of the indicated triggering conditions and/or rules to trigger an L3-based to/from an L1/L2-based CLI-RS measurement and reporting resources. For instance, the UE can use one or more of indicated L3-based to L1/L2-based triggering conditions to activate one or more of subband-based CLI-RS measurements and L1/L2-based reporting resources and/or to deactivate the active subband-based CLI-RS measurements and L3-based reporting resources, such as if the L3-based CLI measurements remain above a (predefined and/or indicated) threshold for a (predefined and/or indicated) time or number of times and/or occasions. The UE, for example, can use one or more of indicated L1/L2-based to L3-based triggering conditions to activate one or more of subband-based CLI-RS measurements and L3-based reporting resources and/or to deactivate the active subband-based CLI-RS measurements and L1/L2-based reporting resources, such as if the difference between L1/L2 subband-based CLI measurements are below a (predefined and/or indicated) threshold for a (predefined and/or indicated) period of time and/or number of times and/or occasions, e.g., CLI measurements over different subbands are approximately equal.

In implementations, when a UE activates and/or deactivates one or more of CLI-RS subband measurement and reporting resources using one or more of indicated triggering conditions and/or rules, the UE can transmit a notification message to the serving network node (e.g., via an uplink control information (UCI)) where the message indicates the indexes of the activated and/or deactivated CLI-RS subband measurements and reporting resources.

In implementations a UE can switch between resources based at least in part on receiving an activation and/or a deactivation message from the serving network node (e.g., gNB), such as via a DCI message, a RRC message, and/or MAC CE. The message, for instance, activates one or more CLI-RS measurement and reporting resources and/or deactivates one or more CLI-RS measurements and reporting resources. In at least some examples, the message can deactivate and/or activate one or more of the indicated L3-based to L1/L2-based triggering conditions.

In implementations a UE can use one or more of SR-triggering conditions to trigger and transmit a CLI-RS measurement and/or reporting resources SR message. The SR message, for instance, can be transmitted via an uplink control information (UCI) but not with an associated CLI measurements reporting resources, and thus the UE may trigger a SR for one or more of CLI measurements reporting resources where the SR message indicates one or more of: CLI-RS measurements and/or reporting resources type index, where each type indicates a different configuration in terms of, e.g., L3-based or L1/L2-based, granularity of subbands, and/or different subbands sizes; measured CLI level values or class (e.g., high/low) with current active CLI-RS measurement resources; and/or the index of the SR triggering condition, e.g., in scenarios where SR triggering conditions implicitly indicate a CLI-RS measurements and/or reporting resources type or index, such as where condition #x indicates a SR for L3-based CLI-RS measurement resources with x granularity of subbands.

According to implementations, the UE can receive from the serving network node a SG message (e.g., via a DCI message or an RRC) indicting on or more of CLI-RS measurements and/or reporting resources configuration.

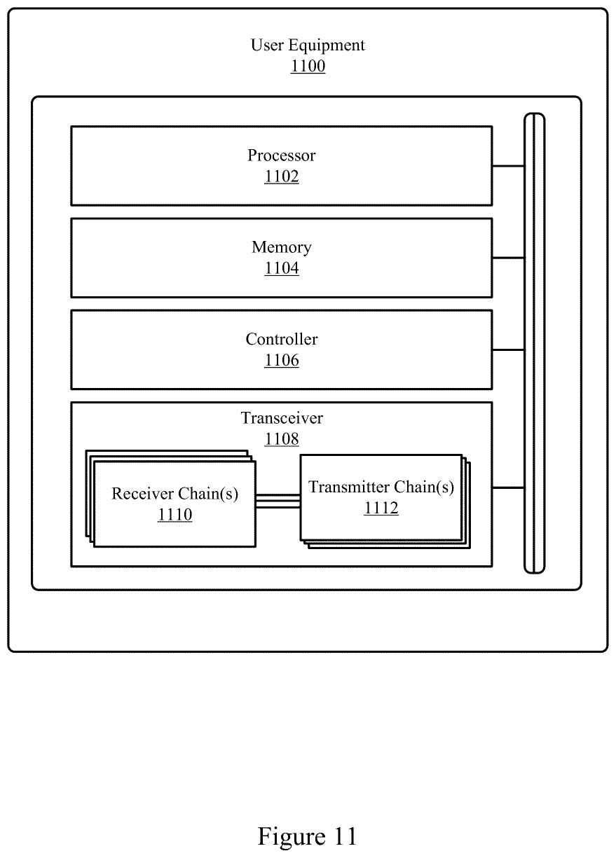

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the functions described herein (e.g., executing, by the processor 1102, instructions stored in the memory 1104). For example, the processor 1102 may support wireless communication at the UE 1100 in accordance with examples as disclosed herein. The UE 1100 may be configured to or operable to support a means for receiving, from a NE, a configuration message for UE-to-UE CLI measurement and reporting, the configuration message including two or more CLI-RS measurement resources and CLI reporting resources associated with a different number of subbands and different CLI reporting resource types; performing CLI measurement based at least in part on one or more of the CLI-RS measurement resources or the CLI reporting resources to generate a CLI report; and transmitting, to the NE, the CLI report using one or more CLI reporting resources of the different CLI reporting resource types.

Additionally, the UE 1100 may be configured to support any one or combination of where one or more of the CLI-RS measurement resources or the CLI reporting resources include at least one of: one or more subband-based CLI-RS measurement resources associated with a plurality of L3-based subband CLI reporting resources; one or more subband-based CLI-RS measurement resources associated with a plurality of L1/L2-based subband CLI reporting resources; at least one of one or more first triggering conditions or one or more first triggering rules for triggering an L3-based-to-L1/L2-based subband CLI measurement resource and CLI reporting resource; at least one of one or more second triggering conditions or one or more second triggering rules for triggering an L3-based-from-L1/L2-based subband CLI-RS measurement resource and CLI reporting resource; or one or more SR resources associated with one or more of SR triggering conditions or SR triggering rules; one or more of the first triggering conditions, the first triggering rules, the second triggering conditions, or the second triggering rules include one or more of: one or more of triggering conditions or triggering rules to trigger high-granularity subband-based CLI-RS measurement resources and CLI reporting resources to low-granularity subband-based CLI-RS measurement resources and CLI reporting resources; one or more of triggering conditions or triggering rules to trigger high-granularity subband-based CLI-RS measurement resources and CLI reporting resources from low-granularity subband-based CLI-RS measurement resources and CLI reporting resources; one or more of triggering conditions or triggering rules to trigger uniform-size subband-based CLI-RS measurement resources and CLI reporting resources to nonuniform-based subband-based CLI-RS measurement resources and CLI reporting resources; or one or more of triggering conditions or triggering rules to trigger uniform-size subband-based CLI-RS measurement resources and CLI reporting resources from nonuniform-based subband-based CLI-RS measurement resources and CLI reporting resources.

Additionally, the UE 1100 may be configured to support any one or combination of where the CLI-RS measurement resources include one or more of SRS-RSRP or CLI-RSSI resources; different subband-based CLI-RS measurement resources and CLI reporting resources include one or more of different granularity of subbands or different subband sizes; one or more of the CLI-RS measurement resources or the CLI reporting resources are indicated for one or more of SBFD and non-SBFD symbols or SBFD and non-SBFD slots; one or more of the CLI-RS measurement resources or the CLI reporting resources are indicated for one or more of SBFD symbols or SBFD slots, and one or more of the CLI-RS measurement resources or the CLI reporting resources are indicated for one or more of non-SBFD symbols or non-SBFD slots; two or more of the CLI-RS measurement resources are associated with one CLI reporting resource; two or more of the CLI reporting resources are associated with one CLI-RS measurement resource.

Additionally, the UE 1100 may be configured to support any one or combination of where one or more of the CLI-RS measurement resources and CLI reporting resources are indicated as active, and one or more of the CLI-RS measurement resources and CLI reporting resources are indicated as inactive; using one or more triggering conditions to activate one or more inactive CLI-RS measurement resources and one or more inactive CLI reporting resources; using one or more triggering conditions to deactivate one or more active CLI-RS measurement resources and one or more active CLI reporting resources; transmitting a notification message to the NE indicating one or more of indexes of activated CLI-RS measurement resources and activated CLI reporting resources, or indexes of deactivated CLI-RS measurement resources and deactivated CLI reporting resources; In some aspects, the techniques described herein relate to a method, further including transmitting the notification message via an UCI message; receiving an activation message from the NE to activate one or more inactive CLI-RS measurement resources and activate one or more inactive CLI reporting resources; receiving a deactivation message from the NE to deactivate one or more active CLI-RS measurement resources and deactivate one or more active CLI reporting resources; receiving an activation message from the NE to activate one or more triggering conditions; receiving a deactivation message from the NE to deactivate one or more triggering conditions; receiving, from the NE and via one or more of a DCI message, a RRC message, or a MAC-CE message, one or more of: an activation message to activate one or more inactive CLI-RS measurement resources and activate one or more inactive CLI reporting resources; a deactivation message to deactivate one or more active CLI-RS measurement resources and deactivate one or more active CLI reporting resources; an activation message to activate one or more triggering conditions; or a deactivation message from the NE to deactivate one or more triggering conditions.

Additionally, the UE 1100 may be configured to support any one or combination of where the UE is configured with CLI-RS measurement resources for CLI monitoring without associated CLI reporting resources; transmitting, to the NE, a SR message for a CLI reporting resource configuration in response to a trigger of a SR condition; the SR message indicates at least one of a CLI-RS measurement resource type index, a CLI reporting resource type index, a measured CLI level, or an index of the triggered SR condition; receiving, from NE, a SG message indicating one or more CLI-RS measurement resources, CLI reporting resources, or a combination thereof; receiving the SG message via one or more of a DCI message or a RRC message; transmitting, to the NE, a SR message for the CLI measurement and reporting configurations in response to a trigger of a SR condition; the SR message indicates at least one of a CLI-RS measurement resource type index, a CLI reporting resource type index, a measured CLI level, or an index of the triggered SR condition; receiving, from NE, a SG message indicating one or more CLI-RS measurements resources, CLI reporting resources, or a combination thereof; receiving the SG message via one or more of a DCI message or a RRC message.

Additionally, or alternatively, the UE 1100 may support at least one memory (e.g., the memory 1104) and at least one processor (e.g., the processor 1102) coupled with the at least one memory and configured to cause the UE to receive, from a NE, a configuration message for UE-to-UE CLI measurement and reporting, the configuration message including two or more CLI-RS measurement resources and CLI reporting resources associated with a different number of subbands and different CLI reporting resource types; perform CLI measurement based at least in part on one or more of the CLI-RS measurement resources or the CLI reporting resources to generate a CLI report; and transmit, to the NE, the CLI report using one or more CLI reporting resources of the different CLI reporting resource types.

Additionally, the UE 1100 may be configured to support any one or combination of where one or more of the CLI-RS measurement resources or the CLI reporting resources include at least one of: one or more subband-based CLI-RS measurement resources associated with a plurality of L3-based subband CLI reporting resources; one or more subband-based CLI-RS measurement resources associated with a plurality of L1/L2-based subband CLI reporting resources; at least one of one or more first triggering conditions or one or more first triggering rules for triggering an L3-based-to-L1/L2-based subband CLI measurement resource and CLI reporting resource; at least one of one or more second triggering conditions or one or more second triggering rules for triggering an L3-based-from-L1/L2-based subband CLI-RS measurement resource and CLI reporting resource; or one or more SR resources associated with one or more of SR triggering conditions or SR triggering rules; one or more of the first triggering conditions, the first triggering rules, the second triggering conditions, or the second triggering rules include one or more of: one or more of triggering conditions or triggering rules to trigger high-granularity subband-based CLI-RS measurement resources and CLI reporting resources to low-granularity subband-based CLI-RS measurement resources and CLI reporting resources; one or more of triggering conditions or triggering rules to trigger high-granularity subband-based CLI-RS measurement resources and CLI reporting resources from low-granularity subband-based CLI-RS measurement resources and CLI reporting resources; one or more of triggering conditions or triggering rules to trigger uniform-size subband-based CLI-RS measurement resources and CLI reporting resources to nonuniform-based subband-based CLI-RS measurement resources and CLI reporting resources; or one or more of triggering conditions or triggering rules to trigger uniform-size subband-based CLI-RS measurement resources and CLI reporting resources from nonuniform-based subband-based CLI-RS measurement resources and CLI reporting resources.

Additionally, the UE 1100 may be configured to support any one or combination of where the CLI-RS measurement resources include one or more of SRS-RSRP or CLI-RSSI resources; different subband-based CLI-RS measurement resources and CLI reporting resources include one or more of different granularity of subbands or different subband sizes; one or more of the CLI-RS measurement resources or the CLI reporting resources are indicated for one or more of SBFD and non-SBFD symbols or SBFD and non-SBFD slots; one or more of the CLI-RS measurement resources or the CLI reporting resources are indicated for one or more of SBFD symbols or SBFD slots, and one or more of the CLI-RS measurement resources or the CLI reporting resources are indicated for one or more of non-SBFD symbols or non-SBFD slots; two or more of the CLI-RS measurement resources are associated with one CLI reporting resource; two or more of the CLI reporting resources are associated with one CLI-RS measurement resource; one or more of the CLI-RS measurement resources and CLI reporting resources are indicated as active, and one or more of the CLI-RS measurement resources and CLI reporting resources are indicated as inactive.

Additionally, the UE 1100 may be configured to support any one or combination of where the at least one processor is configured to cause the UE to use one or more triggering conditions to activate one or more inactive CLI-RS measurement resources and one or more inactive CLI reporting resources; the at least one processor is configured to cause the UE to use one or more triggering conditions to deactivate one or more active CLI-RS measurement resources and one or more active CLI reporting resources; the at least one processor is configured to cause the UE to transmit a notification message to the NE indicating one or more of indexes of activated CLI-RS measurement resources and activated CLI reporting resources, or indexes of deactivated CLI-RS measurement resources and deactivated CLI reporting resources; the at least one processor is configured to cause the UE to transmit the notification message via an UCI message; the at least one processor is configured to cause the UE to receive an activation message from the NE to activate one or more inactive CLI-RS measurement resources and activate one or more inactive CLI reporting resources; the at least one processor is configured to cause the UE to receive a deactivation message from the NE to deactivate one or more active CLI-RS measurement resources and deactivate one or more active CLI reporting resources.

Additionally, the UE 1100 may be configured to support any one or combination of where the at least one processor is configured to cause the UE to receive an activation message from the NE to activate one or more triggering conditions; the at least one processor is configured to cause the UE to receive a deactivation message from the NE to deactivate one or more triggering conditions; the at least one processor is configured to cause the UE to receive, from the NE and via one or more of a DCI message, a RRC message, or a MAC-CE message, one or more of: an activation message to activate one or more inactive CLI-RS measurement resources and activate one or more inactive CLI reporting resources; a deactivation message to deactivate one or more active CLI-RS measurement resources and deactivate one or more active CLI reporting resources; an activation message to activate one or more triggering conditions; or a deactivation message from the NE to deactivate one or more triggering conditions; the UE is configured with CLI-RS measurement resources for CLI monitoring without associated CLI reporting resources; the at least one processor is configured to cause the UE to transmit, to the NE, a SR message for a CLI reporting resource configuration in response to a trigger of a SR condition; the SR message indicates at least one of a CLI-RS measurement resource type index, a CLI reporting resource type index, a measured CLI level, or an index of the triggered SR condition.

Additionally, the UE 1100 may be configured to support any one or combination of where the at least one processor is configured to cause the UE to receive, from NE, a SG message indicating one or more CLI-RS measurement resources, CLI reporting resources, or a combination thereof; the at least one processor is configured to cause the UE to receive the SG message via one or more of a DCI message or a RRC message; the at least one processor is configured to cause the UE to transmit, to the NE, a SR message for the CLI measurement and reporting configurations in response to a trigger of a SR condition; the SR message indicates at least one of a CLI-RS measurement resource type index, a CLI reporting resource type index, a measured CLI level, or an index of the triggered SR condition; the at least one processor is configured to cause the UE to receive, from NE, a SG message indicating one or more CLI-RS measurements resources, CLI reporting resources, or a combination thereof; the at least one processor is configured to cause the UE to receive the SG message via one or more of a DCI message or a RRC message.

The controller 1106 may manage input and output signals for the UE 1100. The controller 1106 may also manage peripherals not integrated into the UE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

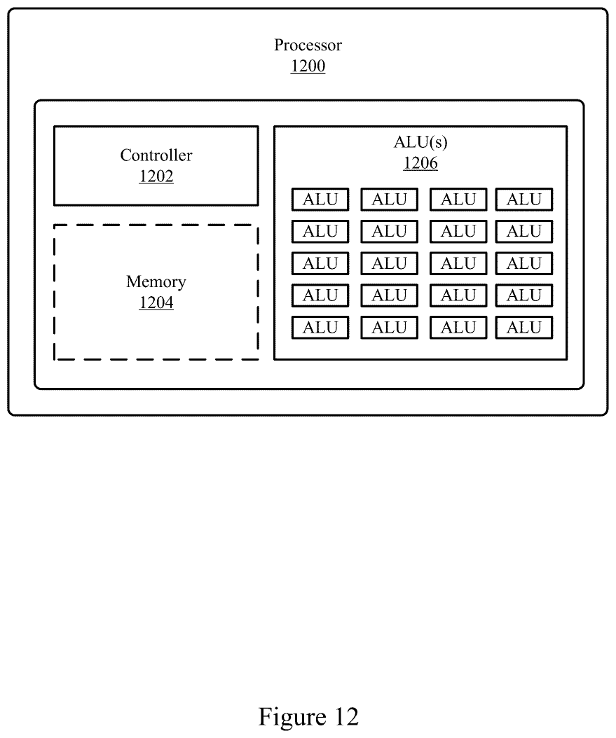

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory addresses of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, ALUs 1206, and other functional units of the processor 1200.

The memory 1204 may include one or more caches (e.g., memory local to or included in the processor 1200 or other memory, such as RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, and the controller 1202, and may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 may be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to or operable to support at least one controller (e.g., the controller 1202) coupled with at least one memory (e.g., the memory 1204) and configured to cause the processor to receive, at a UE and from a NE, a configuration message for UE-to-UE CLI measurement and reporting, the configuration message including two or more CLI-RS measurement resources and CLI reporting resources associated with a different number of subbands and different CLI reporting resource types; perform CLI measurement based at least in part on one or more of the CLI-RS measurement resources or the CLI reporting resources to generate a CLI report; and transmit, to the NE, the CLI report using one or more CLI reporting resources of the different CLI reporting resource types.

Additionally, the processor 1200 may be configured to or operable to support any one or combination of where one or more of the CLI-RS measurement resources or the CLI reporting resources include at least one of: one or more subband-based CLI-RS measurement resources associated with a plurality of L3-based subband CLI reporting resources; one or more subband-based CLI-RS measurement resources associated with a plurality of L1/L2-based subband CLI reporting resources; at least one of one or more first triggering conditions or one or more first triggering rules for triggering an L3-based-to-L1/L2-based subband CLI measurement resource and CLI reporting resource; at least one of one or more second triggering conditions or one or more second triggering rules for triggering an L3-based-from-L1/L2-based subband CLI-RS measurement resource and CLI reporting resource; or one or more SR resources associated with one or more of SR triggering conditions or SR triggering rules; one or more of the first triggering conditions, the first triggering rules, the second triggering conditions, or the second triggering rules include one or more of: one or more of triggering conditions or triggering rules to trigger high-granularity subband-based CLI-RS measurement resources and CLI reporting resources to low-granularity subband-based CLI-RS measurement resources and CLI reporting resources; one or more of triggering conditions or triggering rules to trigger high-granularity subband-based CLI-RS measurement resources and CLI reporting resources from low-granularity subband-based CLI-RS measurement resources and CLI reporting resources; one or more of triggering conditions or triggering rules to trigger uniform-size subband-based CLI-RS measurement resources and CLI reporting resources to nonuniform-based subband-based CLI-RS measurement resources and CLI reporting resources; or one or more of triggering conditions or triggering rules to trigger uniform-size subband-based CLI-RS measurement resources and CLI reporting resources from nonuniform-based subband-based CLI-RS measurement resources and CLI reporting resources.

Additionally, the processor 1200 may be configured to or operable to support any one or combination of where the CLI-RS measurement resources include one or more of SRS-RSRP or CLI-RSSI resources; different subband-based CLI-RS measurement resources and CLI reporting resources include one or more of different granularity of subbands or different subband sizes; one or more of the CLI-RS measurement resources or the CLI reporting resources are indicated for one or more of SBFD and non-SBFD symbols or SBFD and non-SBFD slots; one or more of the CLI-RS measurement resources or the CLI reporting resources are indicated for one or more of SBFD symbols or SBFD slots, and one or more of the CLI-RS measurement resources or the CLI reporting resources are indicated for one or more of non-SBFD symbols or non-SBFD slots.

Additionally, the processor 1200 may be configured to or operable to support any one or combination of where two or more of the CLI-RS measurement resources are associated with one CLI reporting resource; two or more of the CLI reporting resources are associated with one CLI-RS measurement resource; one or more of the CLI-RS measurement resources and CLI reporting resources are indicated as active, and one or more of the CLI-RS measurement resources and CLI reporting resources are indicated as inactive; the at least one controller is configured to cause the processor to use one or more triggering conditions to activate one or more inactive CLI-RS measurement resources and one or more inactive CLI reporting resources; the at least one controller is configured to cause the processor to use one or more triggering conditions to deactivate one or more active CLI-RS measurement resources and one or more active CLI reporting resources; the at least one controller is configured to cause the processor to transmit a notification message to the NE indicating one or more of indexes of activated CLI-RS measurement resources and activated CLI reporting resources, or indexes of deactivated CLI-RS measurement resources and deactivated CLI reporting resources.

Additionally, the processor 1200 may be configured to or operable to support any one or combination of where the at least one controller is configured to cause the processor to transmit the notification message via an UCI message; the at least one controller is configured to cause the processor to receive an activation message from the NE to activate one or more inactive CLI-RS measurement resources and activate one or more inactive CLI reporting resources; the at least one controller is configured to cause the processor to receive a deactivation message from the NE to deactivate one or more active CLI-RS measurement resources and deactivate one or more active CLI reporting resources; the at least one controller is configured to cause the processor to receive an activation message from the NE to activate one or more triggering conditions; the at least one controller is configured to cause the processor to receive a deactivation message from the NE to deactivate one or more triggering conditions; the at least one controller is configured to cause the processor to receive, from the NE and via one or more of a DCI message, a RRC message, or a MAC-CE message, one or more of: an activation message to activate one or more inactive CLI-RS measurement resources and activate one or more inactive CLI reporting resources; a deactivation message to deactivate one or more active CLI-RS measurement resources and deactivate one or more active CLI reporting resources; an activation message to activate one or more triggering conditions; or a deactivation message from the NE to deactivate one or more triggering conditions; the processor is configured with CLI-RS measurement resources for CLI monitoring without associated CLI reporting resources.

Additionally, the processor 1200 may be configured to or operable to support any one or combination of where the at least one controller is configured to cause the processor to transmit, to the NE, a SR message for a CLI reporting resource configuration in response to a trigger of a SR condition; the SR message indicates at least one of a CLI-RS measurement resource type index, a CLI reporting resource type index, a measured CLI level, or an index of the triggered SR condition; the at least one controller is configured to cause the processor to receive, from NE, a SG message indicating one or more CLI-RS measurement resources, CLI reporting resources, or a combination thereof; the at least one controller is configured to cause the processor to receive the SG message via one or more of a DCI message or a RRC message; the at least one controller is configured to cause the processor to transmit, to the NE, a SR message for the CLI measurement and reporting configurations in response to a trigger of a SR condition; the SR message indicates at least one of a CLI-RS measurement resource type index, a CLI reporting resource type index, a measured CLI level, or an index of the triggered SR condition; the at least one controller is configured to cause the processor to receive, from NE, a SG message indicating one or more CLI-RS measurements resources, CLI reporting resources, or a combination thereof; the at least one controller is configured to cause the processor to receive the SG message via one or more of a DCI message or a RRC message.

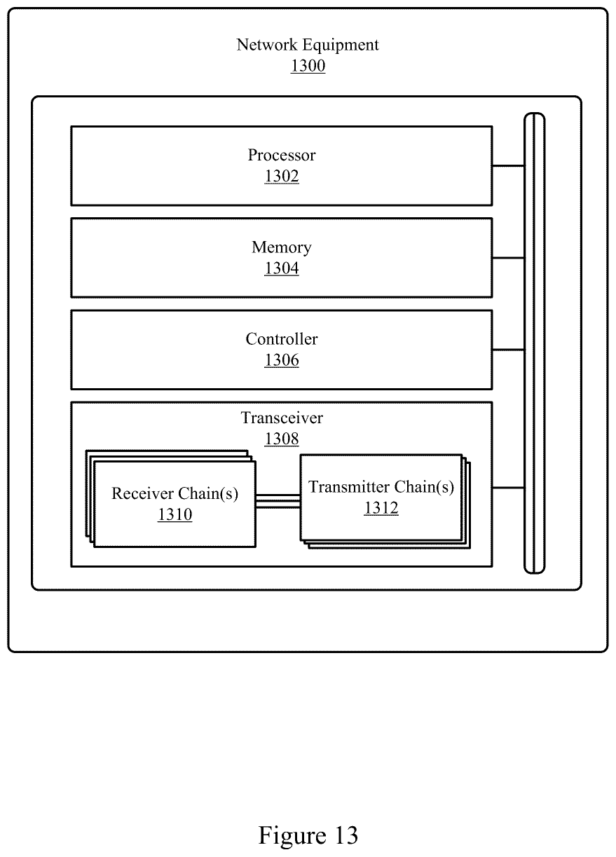

FIG. 13 illustrates an example of a NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein. The NE 1300 may be configured to or operable to support a means for transmitting, to a UE, a configuration message for UE-to-UE CLI measurement and reporting, the configuration message including two or more CLI-RS measurement resources and CLI reporting resources associated with a different number of subbands and different CLI reporting resource types; and receiving, from the UE, a CLI report via one or more CLI reporting resources of the different CLI reporting resource types.

Additionally, the NE 1300 may be configured to or operable to support any one or combination of where one or more of the CLI-RS measurement resources or the CLI reporting resources include at least one of: one or more subband-based CLI-RS measurement resources associated with a plurality of L3-based subband CLI reporting resources; one or more subband-based CLI-RS measurement resources associated with a plurality of L1/L2-based subband CLI reporting resources; at least one of one or more first triggering conditions or one or more first triggering rules for triggering an L3-based-to-L1/L2-based subband CLI measurement resource and CLI reporting resource; at least one of one or more second triggering conditions or one or more second triggering rules for triggering an L3-based-from-L1/L2-based subband CLI-RS measurement resource and CLI reporting resource; or one or more SR resources associated with one or more of SR triggering conditions or SR triggering rules; one or more of the first triggering conditions, the first triggering rules, the second triggering conditions, or the second triggering rules include one or more of: one or more of triggering conditions or triggering rules to trigger high-granularity subband-based CLI-RS measurement resources and CLI reporting resources to low-granularity subband-based CLI-RS measurement resources and CLI reporting resources; one or more of triggering conditions or triggering rules to trigger high-granularity subband-based CLI-RS measurement resources and CLI reporting resources from low-granularity subband-based CLI-RS measurement resources and CLI reporting resources; one or more of triggering conditions or triggering rules to trigger uniform-size subband-based CLI-RS measurement resources and CLI reporting resources to nonuniform-based subband-based CLI-RS measurement resources and CLI reporting resources; or one or more of triggering conditions or triggering rules to trigger uniform-size subband-based CLI-RS measurement resources and CLI reporting resources from nonuniform-based subband-based CLI-RS measurement resources and CLI reporting resources.

Additionally, the NE 1300 may be configured to or operable to support any one or combination of where the CLI-RS measurement resources include one or more of SRS-RSRP or CLI-RSSI resources; different subband-based CLI-RS measurement resources and CLI reporting resources include one or more of different granularity of subbands or different subband sizes; one or more of the CLI-RS measurement resources or the CLI reporting resources are indicated for one or more of SBFD and non-SBFD symbols or SBFD and non-SBFD slots; one or more of the CLI-RS measurement resources or the CLI reporting resources are indicated for one or more of SBFD symbols or SBFD slots, and one or more of the CLI-RS measurement resources or the CLI reporting resources are indicated for one or more of non-SBFD symbols or non-SBFD slots; two or more of the CLI-RS measurement resources are associated with one CLI reporting resource; two or more of the CLI reporting resources are associated with one CLI-RS measurement resource; one or more of the CLI-RS measurement resources and CLI reporting resources are indicated as active, and one or more of the CLI-RS measurement resources and CLI reporting resources are indicated as inactive.

Additionally, the NE 1300 may be configured to or operable to support any one or combination of receiving, from the UE, a notification message indicating one or more of indexes of activated CLI-RS measurement resources and activated CLI reporting resources, or indexes of deactivated CLI-RS measurement resources and deactivated CLI reporting resources; receiving the notification message via an UCI message; transmitting, to the UE, an activation message to activate one or more inactive CLI-RS measurement resources and activate one or more inactive CLI reporting resources; transmitting, to the UE, a deactivation message to deactivate one or more active CLI-RS measurement resources and deactivate one or more active CLI reporting resources; transmitting, to the UE, an activation message to activate one or more triggering conditions; transmitting, to the UE, a deactivation message to deactivate one or more triggering conditions; transmitting, to the UE and via one or more of a DCI message, a RRC message, or a MAC-CE message, one or more of: an activation message to activate one or more inactive CLI-RS measurement resources and activate one or more inactive CLI reporting resources; a deactivation message to deactivate one or more active CLI-RS measurement resources and deactivate one or more active CLI reporting resources; an activation message to activate one or more triggering conditions; or a deactivation message from the NE to deactivate one or more triggering conditions.

Additionally, the NE 1300 may be configured to or operable to support any one or combination of receiving, to from the UE, a SR message for a CLI reporting resource configuration in response to a trigger of a SR condition; the SR message indicates at least one of a CLI-RS measurement resource type index, a CLI reporting resource type index, a measured CLI level, or an index of the triggered SR condition; transmitting, to the UE, a SG message indicating one or more CLI-RS measurement resources, CLI reporting resources, or a combination thereof; transmitting the SG message via one or more of a DCI message or a RRC message; receiving, from the UE, a SR message for the CLI measurement and reporting configurations; the SR message indicates at least one of a CLI-RS measurement resource type index, a CLI reporting resource type index, a measured CLI level, or an index of a triggered SR condition; transmitting, to the UE, a SG message indicating one or more CLI-RS measurements resources, CLI reporting resources, or a combination thereof; transmitting the SG message via one or more of a DCI message or a RRC message.

Additionally, or alternatively, the NE 1300 may support at least one memory (e.g., the memory 1304) and at least one processor (e.g., the processor 1302) coupled with the at least one memory and configured to cause the NE to transmit, to a UE, a configuration message for UE-to-UE CLI measurement and reporting, the configuration message including two or more CLI-RS measurement resources and CLI reporting resources associated with a different number of subbands and different CLI reporting resource types; and receive, from the UE, a CLI report via one or more CLI reporting resources of the different CLI reporting resource types.

Additionally, the NE 1300 may be configured to support any one or combination of where one or more of the CLI-RS measurement resources or the CLI reporting resources include at least one of: one or more subband-based CLI-RS measurement resources associated with a plurality of L3-based subband CLI reporting resources; one or more subband-based CLI-RS measurement resources associated with a plurality of L1/L2-based subband CLI reporting resources; at least one of one or more first triggering conditions or one or more first triggering rules for triggering an L3-based-to-L1/L2-based subband CLI measurement resource and CLI reporting resource; at least one of one or more second triggering conditions or one or more second triggering rules for triggering an L3-based-from-L1/L2-based subband CLI-RS measurement resource and CLI reporting resource; or one or more SR resources associated with one or more of SR triggering conditions or SR triggering rules; one or more of the first triggering conditions, the first triggering rules, the second triggering conditions, or the second triggering rules include one or more of: one or more of triggering conditions or triggering rules to trigger high-granularity subband-based CLI-RS measurement resources and CLI reporting resources to low-granularity subband-based CLI-RS measurement resources and CLI reporting resources; one or more of triggering conditions or triggering rules to trigger high-granularity subband-based CLI-RS measurement resources and CLI reporting resources from low-granularity subband-based CLI-RS measurement resources and CLI reporting resources; one or more of triggering conditions or triggering rules to trigger uniform-size subband-based CLI-RS measurement resources and CLI reporting resources to nonuniform-based subband-based CLI-RS measurement resources and CLI reporting resources; or one or more of triggering conditions or triggering rules to trigger uniform-size subband-based CLI-RS measurement resources and CLI reporting resources from nonuniform-based subband-based CLI-RS measurement resources and CLI reporting resources.

Additionally, the NE 1300 may be configured to support any one or combination of where the CLI-RS measurement resources include one or more of SRS-RSRP or CLI-RSSI resources; different subband-based CLI-RS measurement resources and CLI reporting resources include one or more of different granularity of subbands or different subband sizes; one or more of the CLI-RS measurement resources or the CLI reporting resources are indicated for one or more of SBFD and non-SBFD symbols or SBFD and non-SBFD slots; one or more of the CLI-RS measurement resources or the CLI reporting resources are indicated for one or more of SBFD symbols or SBFD slots, and one or more of the CLI-RS measurement resources or the CLI reporting resources are indicated for one or more of non-SBFD symbols or non-SBFD slots; two or more of the CLI-RS measurement resources are associated with one CLI reporting resource; two or more of the CLI reporting resources are associated with one CLI-RS measurement resource; one or more of the CLI-RS measurement resources and CLI reporting resources are indicated as active, and one or more of the CLI-RS measurement resources and CLI reporting resources are indicated as inactive.

Additionally, the NE 1300 may be configured to support any one or combination of where the at least one processor is configured to cause the NE to receive, from the UE, a notification message indicating one or more of indexes of activated CLI-RS measurement resources and activated CLI reporting resources, or indexes of deactivated CLI-RS measurement resources and deactivated CLI reporting resources; the at least one processor is configured to cause the NE to receive the notification message via an UCI message; the at least one processor is configured to cause the NE to transmit, to the UE, an activation message to activate one or more inactive CLI-RS measurement resources and activate one or more inactive CLI reporting resources; the at least one processor is configured to cause the NE to transmit, to the UE, a deactivation message to deactivate one or more active CLI-RS measurement resources and deactivate one or more active CLI reporting resources; the at least one processor is configured to cause the NE to transmit, to the UE, an activation message to activate one or more triggering conditions.

Additionally, the NE 1300 may be configured to support any one or combination of where the at least one processor is configured to cause the NE to transmit, to the UE, a deactivation message to deactivate one or more triggering conditions; the at least one processor is configured to cause the NE to transmit, to the UE and via one or more of a DCI message, a RRC message, or a MAC-CE message, one or more of: an activation message to activate one or more inactive CLI-RS measurement resources and activate one or more inactive CLI reporting resources; a deactivation message to deactivate one or more active CLI-RS measurement resources and deactivate one or more active CLI reporting resources; an activation message to activate one or more triggering conditions; or a deactivation message from the NE to deactivate one or more triggering conditions; the at least one processor is configured to cause the NE to receive, to from the UE, a SR message for a CLI reporting resource configuration in response to a trigger of a SR condition; the SR message indicates at least one of a CLI-RS measurement resource type index, a CLI reporting resource type index, a measured CLI level, or an index of the triggered SR condition.

Additionally, the NE 1300 may be configured to support any one or combination of where the at least one processor is configured to cause the NE to transmit, to the UE, a SG message indicating one or more CLI-RS measurement resources, CLI reporting resources, or a combination thereof; the at least one processor is configured to cause the NE to transmit the SG message via one or more of a DCI message or a RRC message; the at least one processor is configured to cause the NE to receive, from the UE, a SR message for the CLI measurement and reporting configurations; the SR message indicates at least one of a CLI-RS measurement resource type index, a CLI reporting resource type index, a measured CLI level, or an index of a triggered SR condition; the at least one processor is configured to cause the NE to transmit, to the UE, a SG message indicating one or more CLI-RS measurements resources, CLI reporting resources, or a combination thereof; the at least one processor is configured to cause the NE to transmit the SG message via one or more of a DCI message or a RRC message.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

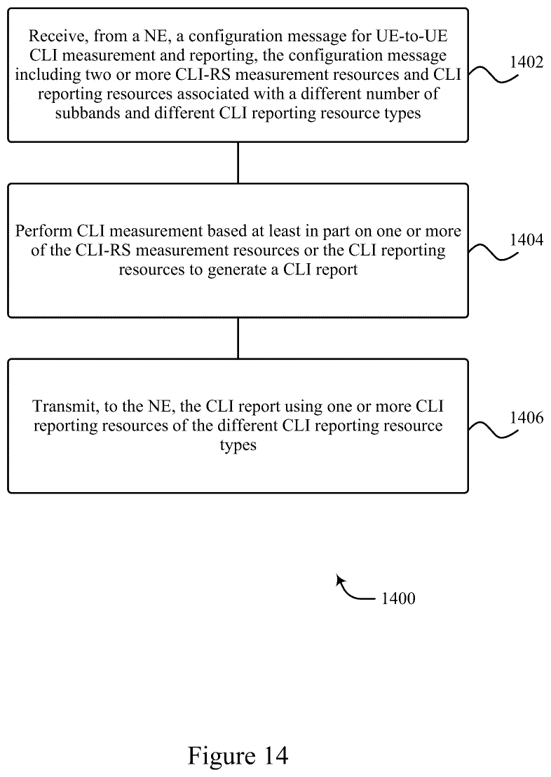

FIG. 14 illustrates a flowchart of a method 1400 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1402, the method may include receiving, from a NE, a configuration message for UE-to-UE CLI measurement and reporting, the configuration message including two or more CLI-RS measurement resources and CLI reporting resources associated with a different number of subbands and different CLI reporting resource types. The operations of 1402 may be performed in accordance with examples as described herein. In some implementations, aspects of the operations of 1402 may be performed by a UE as described with reference to FIG. 11.

At 1404, the method may include performing CLI measurement based at least in part on one or more of the CLI-RS measurement resources or the CLI reporting resources to generate a CLI report. The operations of 1404 may be performed in accordance with examples as described herein. In some implementations, aspects of the operations of 1404 may be performed by a UE as described with reference to FIG. 11.

At 1406, the method may include transmitting, to the NE, the CLI report using one or more CLI reporting resources of the different CLI reporting resource types. The operations of 1406 may be performed in accordance with examples as described herein. In some implementations, aspects of the operations of 1406 may be performed a UE as described with reference to FIG. 11.

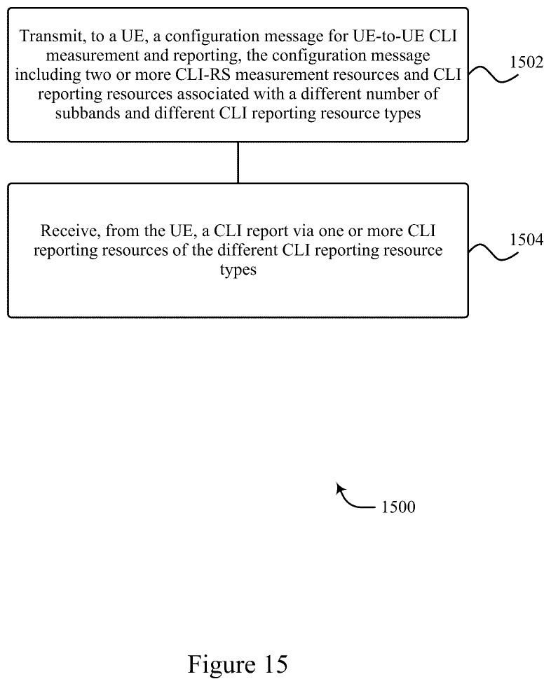

FIG. 15 illustrates a flowchart of a method 1500 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1502, the method may include transmitting, to a UE, a configuration message for UE-to-UE CLI measurement and reporting, the configuration message including two or more CLI-RS measurement resources and CLI reporting resources associated with a different number of subbands and different CLI reporting resource types. The operations of 1502 may be performed in accordance with examples as described herein. In some implementations, aspects of the operations of 1502 may be performed by a NE as described with reference to FIG. 13.

At 1504, the method may include receiving, from the UE, a CLI report via one or more CLI reporting resources of the different CLI reporting resource types. The operations of 1504 may be performed in accordance with examples as described herein. In some implementations, aspects of the operations of 1504 may be performed by a NE as described with reference to FIG. 13.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network equipment (NE), a configuration message for UE-to-UE Cross-Link Interference (CLI) measurement and reporting, the configuration message comprising two or more CLI reference signal (RS) (CLI-RS) measurement resources and CLI reporting resources associated with a different number of subbands and different CLI reporting resource types;
perform CLI measurement based at least in part on one or more of the CLI-RS measurement resources or the CLI reporting resources to generate a CLI report; and
transmit, to the NE, the CLI report using one or more CLI reporting resources of the different CLI reporting resource types.

2. The UE of claim 1, wherein one or more of the CLI-RS measurement resources or the CLI reporting resources comprise at least one of:
one or more subband-based CLI-RS measurement resources associated with a plurality of Layer 3 (L3)-based subband CLI reporting resources;
one or more subband-based CLI-RS measurement resources associated with a plurality of Layer 1 (L1)/Layer 2 (L2)-based subband CLI reporting resources;
at least one of one or more first triggering conditions or one or more first triggering rules for triggering an L3-based-to-L1/L2-based subband CLI measurement resource and CLI reporting resource;
at least one of one or more second triggering conditions or one or more second triggering rules for triggering an L3-based-from-L1/L2-based subband CLI-RS measurement resource and CLI reporting resource; or
one or more scheduling request (SR) resources associated with one or more of SR triggering conditions or SR triggering rules.

3. The UE of claim 2, wherein one or more of the first triggering conditions, the first triggering rules, the second triggering conditions, or the second triggering rules comprise one or more of:
one or more of triggering conditions or triggering rules to trigger high-granularity subband-based CLI-RS measurement resources and CLI reporting resources to low-granularity subband-based CLI-RS measurement resources and CLI reporting resources;
one or more of triggering conditions or triggering rules to trigger high-granularity subband-based CLI-RS measurement resources and CLI reporting resources from low-granularity subband-based CLI-RS measurement resources and CLI reporting resources;
one or more of triggering conditions or triggering rules to trigger uniform-size subband-based CLI-RS measurement resources and CLI reporting resources to nonuniform-based subband-based CLI-RS measurement resources and CLI reporting resources; or
one or more of triggering conditions or triggering rules to trigger uniform-size subband-based CLI-RS measurement resources and CLI reporting resources from nonuniform-based subband-based CLI-RS measurement resources and CLI reporting resources.

4. The UE of claim 1, wherein the CLI-RS measurement resources comprise one or more of Sounding Reference Signal Reference Signal Received Power (SRS-RSRP) or CLI Received Signal Strength Indicator (CLI-RSSI) resources.

5. The UE of claim 1, wherein different subband-based CLI-RS measurement resources and CLI reporting resources comprise one or more of different granularity of subbands or different subband sizes.

6. The UE of claim 1, wherein one or more of the CLI-RS measurement resources or the CLI reporting resources are indicated for one or more of Subband Full Duplex (SBFD) and non-SBFD symbols or SBFD and non-SBFD slots.

7. The UE of claim 1, wherein one or more of the CLI-RS measurement resources or the CLI reporting resources are indicated for one or more of Subband Full Duplex (SBFD) symbols or SBFD slots, and one or more of the CLI-RS measurement resources or the CLI reporting resources are indicated for one or more of non-SBFD symbols or non-SBFD slots.

8. The UE of claim 1, wherein two or more of the CLI-RS measurement resources are associated with one CLI reporting resource.

9. The UE of claim 1, wherein two or more of the CLI reporting resources are associated with one CLI-RS measurement resource.

10. The UE of claim 1, wherein one or more of the CLI-RS measurement resources and CLI reporting resources are indicated as active, and one or more of the CLI-RS measurement resources and CLI reporting resources are indicated as inactive.

11. The UE of claim 1, wherein the at least one processor is configured to cause the UE to use one or more triggering conditions to activate one or more inactive CLI-RS measurement resources and one or more inactive CLI reporting resources.

12. The UE of claim 1, wherein the at least one processor is configured to cause the UE to use one or more triggering conditions to deactivate one or more active CLI-RS measurement resources and one or more active CLI reporting resources.

13. The UE of claim 1, wherein the at least one processor is configured to cause the UE to transmit a notification message to the NE indicating one or more of indexes of activated CLI-RS measurement resources and activated CLI reporting resources, or indexes of deactivated CLI-RS measurement resources and deactivated CLI reporting resources.

14. The UE of claim 13, wherein the at least one processor is configured to cause the UE to transmit the notification message via an Uplink Control Information (UCI) message.

15. The UE of claim 1, wherein the at least one processor is configured to cause the UE to receive an activation message from the NE to activate one or more inactive CLI-RS measurement resources and activate one or more inactive CLI reporting resources.

16. The UE of claim 1, wherein the at least one processor is configured to cause the UE to receive a deactivation message from the NE to deactivate one or more active CLI-RS measurement resources and deactivate one or more active CLI reporting resources.

17. The UE of claim 1, wherein the at least one processor is configured to cause the UE to receive an activation message from the NE to activate one or more triggering conditions.

18. A processor for wireless communication, comprising:
at least one controller coupled with at least one memory and configured to cause the processor to:
receive, at a user equipment (UE) and from a network equipment (NE), a configuration message for UE-to-UE Cross-Link Interference (CLI) measurement and reporting, the configuration message comprising two or more CLI reference signal (RS) (CLI-RS) measurement resources and CLI reporting resources associated with a different number of subbands and different CLI reporting resource types;
perform CLI measurement based at least in part on one or more of the CLI-RS measurement resources or the CLI reporting resources to generate a CLI report; and
transmit, to the NE, the CLI report using one or more CLI reporting resources of the different CLI reporting resource types.

19. A network equipment (NE) for wireless communication, comprising:
at least one memory; and
at least one processor coupled with the at least one memory and configured to cause the NE to:
transmit, to a user equipment (UE), a configuration message for UE-to-UE Cross-Link Interference (CLI) measurement and reporting, the configuration message comprising two or more CLI reference signal (RS) (CLI-RS) measurement resources and CLI reporting resources associated with a different number of subbands and different CLI reporting resource types; and
receive, from the UE, a CLI report via one or more CLI reporting resources of the different CLI reporting resource types.

20. A method performed by a user equipment (UE), the method comprising:
receiving, from a network equipment (NE), a configuration message for UE-to-UE Cross-Link Interference (CLI) measurement and reporting, the configuration message comprising two or more CLI reference signal (RS) (CLI-RS) measurement resources and CLI reporting resources associated with a different number of subbands and different CLI reporting resource types;
performing CLI measurement based at least in part on one or more of the CLI-RS measurement resources or the CLI reporting resources to generate a CLI report; and
transmitting, to the NE, the CLI report using one or more CLI reporting resources of the different CLI reporting resource types.
